(19) United States
(12) Patent Application Publication
(10) Pub. No.: US 2023/0224408 A1
(43) Pub. Date: Jul. 13, 2023

(54) SYSTEM AND METHOD FOR CALLBACK MANAGEMENT WITH ALTERNATE SITE ROUTING AND CONTEXT-AWARE CALLBACK PACING

(71) Applicant: Virtual Hold Technology Solutions, LLC, Akron, OH (US)

(72) Inventors: Daniel Bohannon, Livermore, CA (US); Matthew DiMaria, Brentwood, TN (US); Shannon Lekas, Cushing, TX (US); Kurt Nelson, Thompsons Station, OH (US); Nicholas James Kennedy, Akron, OH (US); Robert Harpley, Akron, OH (US)

(21) Appl. No.: 18/157,819

(22) Filed: Jan. 21, 2023

Related U.S. Application Data
(63) Continuation-in-part of application No. 17/844,047, filed on Jun. 19, 2022, now Pat. No. 11,641,423.
Application No. 17/844,047 is a continuation of application No. 17/540,130, filed on Dec. 1, 2021, now Pat. No. 11,418,650.
Application No. 17/540,130 is a continuation-in-part of application No. 17/336,405, filed on Jun. 2, 2021, now Pat. No. 11,522,997.
Application No. 17/336,405 is a continuation of application No. 17/011,248, filed on Sep. 3, 2020, now Pat. No. 11,032,424.
Application No. 17/011,248 is a continuation-in-part of application No. 16/995,424, filed on Aug. 17, 2020, now abandoned.
Application No. 16/995,424 is a continuation-in-part of application No. 16/896,108, filed on Jun. 8, 2020, now abandoned.
Application No. 16/896,108 is a continuation-in-part of application No. 16/836,798, filed on Mar. 31, 2020, now Pat. No. 10,992,811.
Application No. 16/836,798 is a continuation of application No. 16/542,577, filed on Aug. 16, 2019, now Pat. No. 10,609,218.
Application No. 16/542,577 is a continuation-in-part of application No. 16/152,403, filed on Oct. 4, 2018, now abandoned.
Application No. 16/152,403 is a continuation-in-part of application No. 16/058,044, filed on Aug. 8, 2018, now Pat. No. 11,012,568.
Application No. 16/058,044 is a continuation-in-part of application No. 14/532,001, filed on Nov. 4, 2014, now Pat. No. 10,375,245.
Application No. 14/532,001 is a continuation-in-part of application No. 13/659,902, filed on Oct. 24, 2012, now Pat. No. 8,938,221.
Application No. 13/659,902 is a continuation-in-part of application No. 13/479,870, filed on May 24, 2012, now Pat. No. 9,055,149.
Application No. 13/479,870 is a continuation-in-part of application No. 12/320,517, filed on Jan. 28, 2009, now Pat. No. 8,213,911.
Application No. 13/659,902 is a continuation-in-part of application No. 13/446,758, filed on Apr. 13, 2012, now Pat. No. 8,792,866.
Application No. 13/446,758 is a continuation of application No. 12/320,517, filed on Jan. 28, 2009, now Pat. No. 8,213,911.
Application No. 12/320,517 is a continuation-in-part of application No. 17/358,331, filed on Jun. 25, 2021, now Pat. No. 11,546,472.
Application No. 17/358,331 is a continuation-in-part of application No. 17/336,405, filed on Jun. 2, 2021, now Pat. No. 11,522,997.
Application No. 17/336,405 is a continuation-in-part of application No. 16/591,096, filed on Oct. 2, 2019, now Pat. No. 11,431,847.
Application No. 16/591,096 is a continuation of application No. 15/411,534, filed on Jan. 20, 2017, now Pat. No. 10,455,090.
(60) Provisional application No. 62/820,190, filed on Mar. 18, 2019.
(60) Provisional application No. 62/858,454, filed on Jun. 7, 2019.
(60) Provisional application No. 62/291,049, filed on Feb. 4, 2016.

(51) Int. Cl. H04M 3/523; H04L 67/306; H04M 3/51

(52) U.S. Cl. CPC H04M 3/5231; H04L 67/306; H04M 3/5183

(57) ABSTRACT

A system and method for optimizing callback times to increase the success rate of callbacks while managing overflow of calls to alternate sites when callbacks are unsuccessful. The system and method use a context-aware pacing algorithm to determine when callbacks are likely to be successful from a preferred contact site, routing to alternate callback sites when callbacks are unsuccessful, and preferences for re-routing back to the preferred site when a callback is successful and the agent with whom the caller has interacted previously is available.

### CROSS-REFERENCE TO RELATED APPLICATIONS

Priority is claimed in the application data sheet to the following patents or patent applications, each of which is expressly incorporated herein by reference in its entirety:

Ser. No. 17/844,047

Ser. No. 17/336,405

Ser. No. 17/358,331

Ser. No. 16/591,096

Ser. No. 15/411,534

62/291,049

Ser. No. 17/011,248

Ser. No. 16/995,424

Ser. No. 16/896,108

Ser. No. 16/836,798

Ser. No. 16/542,577

62/820,190

62/858,454

Ser. No. 16/152,403

Ser. No. 16/058,044

Ser. No. 14/532,001

Ser. No. 13/659,902

Ser. No. 13/479,870

Ser. No. 12/320,517

Ser. No. 13/446,758

### BACKGROUND OF THE INVENTION

### Field of the Art

The disclosure relates to the field of contact center technology, specifically to the field of cloud-implemented automated callback systems.

### Discussion of the State of the Art

Large volumes of caller traffic at a contact center may cause long queues of callback requests. While callback queues reduce the burden on callers by not requiring them to wait on hold, callback queues present other problems such as failed callback dialing attempts, unanswered callbacks, and dropped calls during callbacks. These problems may increase the time between successful callback attempts, which can be a burden on contact center resources.

One existing solution to the burden caused by repeated callbacks is the use of alternate contact sites from which callback attempts can be made. Using alternate contact sites to make callback attempts can potentially increase the number of callback attempts possible without burdening the primary contact center site. However, routing inefficiencies may cause alternate contact sites to go underutilized, reducing their effectiveness. Further, routing of callbacks to alternate contact sites does not solve the problems inherent in use of callback queues. Callback problems such as those noted above (failed callback dialing attempts, unanswered callbacks, dropped calls, etc.) may cause the caller to be placed back into the callback queue at the alternate contact site in the same manner as at the primary contact center. Further, routing to alternate contact sites may cause discontinuity in caller/agent relations in cases where there have been previous contacts between a particular caller and a particular agent.

What is needed is a system and method for optimizing callback times to increase the success rate of callbacks while managing overflow of calls to alternate sites when callbacks are unsuccessful.

### SUMMARY OF THE INVENTION

Accordingly, the inventor has conceived, and reduced to practice, a system and method for optimizing callback times to increase the success rate of callbacks while managing overflow of calls to alternate sites when callbacks are unsuccessful. The system and method use a context-aware pacing algorithm to determine when callbacks are likely to be successful from a preferred contact site, routing to alternate callback sites when callbacks are unsuccessful, and preferences for re-routing back to the preferred site when a callback is successful and the agent with whom the caller has interacted previously is available.

According to a preferred embodiment, A system for callback management with alternate site routing and context-aware callback pacing, comprising: a computing device comprising a memory and a processor; a context analysis engine comprising a first plurality of programming instructions stored in the memory and operating on the processor, wherein the first plurality of programming instructions, cause the computing device to: receive device information, caller data, and external data; process the device information, the caller data, and the external data to generate context content data; and forward the context content to a pacing algorithm; and the pacing algorithm comprising a second plurality of programming instructions stored in the memory and operating on the processor of the computing device, wherein the second plurality of programming instructions, cause the computing device to: receive callback objects from a callback cloud service; determine times when a caller and an agent are both likely to be available; predict a likelihood that the caller will answer at each determined time; predict a caller sentiment when answering at each determined time; aggregate the predicted likelihood that the caller will answer and the predicted caller sentiment when answering to select a callback time; and send the callback time to an on-premise callback system.

According to another preferred embodiment, a method for callback management with alternate site routing and context-aware callback pacing is disclosed, comprising the steps of: receiving device information, caller data, and external data; processing the device information, the caller data, and the external data to generate context content data; forwarding the context content to a pacing algorithm; receiving callback objects from a callback cloud service; determining times when a caller and an agent are both likely to be available; predicting a likelihood that the caller will answer at each determined time; predicting a caller sentiment when answering at each determined time; aggregating the predicted likelihood that the caller will answer and the predicted caller sentiment when answering to select a callback time; and sending the callback time to an on-premise callback system.

According to an aspect of an embodiment, an on-premise callback system operating at a preferred contact site comprising a third plurality of programming instructions stored in the memory and operating on the processor of the computing device, wherein the third plurality of programming instructions, cause the computing device to: communicate with the callback cloud service; send data related to callback objects and agents to the callback cloud service; receive a call to an agent from a caller; create a callback object upon the caller's request for a callback; receive the callback time from a pacing algorithm; and execute a callback to the caller at the callback time.

According to an aspect of an embodiment, the callback cloud service comprising a second computing device comprising a memory and a processor, and a fourth plurality of programming instructions stored in the memory and operating on the processor of the second computing device, which causes the second computing device to: communicate with the on-premise callback system; maintain relevant agent and client data from the on-premise callback system; interface with one or more alternate sites comprising of an on-premise callback system; and execute callback fulfillment requests.

According to an aspect of an embodiment, the pacing algorithm further: determines a callback attempt limit; increments a counter each time a failed callback is made to the caller; and upon reaching callback attempt limit, routes remaining callback attempts to an alternate contact site.

According to an aspect of an embodiment, a second on-premise callback system operating at an alternate contact site, the second on-premise callback system comprising a third computing device comprising a memory and a processor, and a fourth plurality of programming instructions stored in the memory and operating on the processor of the third computing device, which causes the third computing device to: receive the routing from the pacing algorithm; determine a callback time; immediately prior to the callback time, determine whether a preferred agent at the preferred callback site is available; if the preferred agent is available, route the callback to the preferred contact site for execution; and if the preferred agent is not available, execute the callback to the caller from the alternate contact site.

According to an aspect of an embodiment, the device information comprises application data, device location data, contact list data, and schedule data.

According to an aspect of an embodiment, the context content data comprises environmental context data, intent context data, and sentiment context data.

According to an aspect of an embodiment, the context content data is assigned weighted values.

According to an aspect of an embodiment, the assigned weighted values are based on the richness of the context content data.

According to an aspect of an embodiment, the assigned weights values are learned and assigned by the pacing algorithm.

### BRIEF DESCRIPTION OF THE DRAWING FIGURES

The accompanying drawings illustrate several aspects and, together with the description, serve to explain the principles of the invention according to the aspects. It will be appreciated by one skilled in the art that the particular arrangements illustrated in the drawings are merely exemplary, and are not to be considered as limiting of the scope of the invention or the claims herein in any way.

FIG. 1 (PRIOR ART) is a block diagram illustrating an on-premise callback system.

FIG. 2 is a block diagram illustrating an exemplary system architecture for operating a callback cloud, according to one aspect.

FIG. 3 is a block diagram illustrating an exemplary system architecture for a callback cloud operating over a public switched telephone network and internet, to a variety of other brand devices and services, according to an embodiment.

FIG. 4 is a block diagram illustrating an exemplary system architecture for a callback cloud operating including a brand interface server and intent analyzer, over a public switched telephone network and internet, to a variety of other brand devices and services, according to an embodiment.

FIG. 5 is a block diagram illustrating an exemplary system architecture for a hybrid callback system operating with a callback cloud and an on-premise callback stack, according to an embodiment.

FIG. 6 is a block diagram illustrating an exemplary system architecture for a hybrid callback system operating with a callback cloud and an on-premise callback stack, and a broker server, according to an embodiment.

FIG. 7 (PRIOR ART) is a method diagram illustrating steps in the operation of an on-premise callback system.

FIG. 8 is a method diagram illustrating the use of a callback cloud for intent-based active callback management, according to an embodiment.

FIG. 9 is a method diagram illustrating the operation of a distributed hybrid callback system architecture utilizing cloud services and on-premise services, according to an embodiment.

FIG. 10 is a method diagram illustrating the use of callback cloud services to aid in the recovery of an on-premise callback system in the event of a premise callback server failure.

FIG. 11 is a method diagram illustrating the use of callback cloud services to aid in the recovery of an on-premise callback system in the event of a total system failure.

FIG. 12 is a method diagram illustrating the use of callback cloud services to aid in the recovery of an on-premise callback system in the event of a premise automatic call distribution and callback server failure.

FIG. 13 is a method diagram illustrating the use of callback cloud services to aid in the recovery of an on-premise callback system in the event of a partial system failure, using a broker server to leverage third-party resources for failure recovery.

FIG. 14 is a method diagram illustrating calculation and recalculation of an estimated wait-time (EWT) for a distributed callback system.

FIG. 15 is a message flow diagram illustrating the operation of a distributed hybrid callback system architecture utilizing cloud services and on-premise services, according to an embodiment.

FIG. 16 is a message flow diagram illustrating the use of callback cloud services to aid in the recovery of an on-premise callback system in the event of a premise callback server failure.

FIG. 17 is a message flow diagram illustrating the use of callback cloud services to aid in the recovery of an on-premise callback system in the event of a total system failure.

FIG. 18 is a message flow diagram illustrating the use of callback cloud services to aid in the recovery of an on-premise callback system in the event of a premise automatic call distribution and callback server failure.

FIG. 19 is a message flow diagram illustrating the use of callback cloud services to aid in the recovery of an on-premise callback system in the event of a partial system failure, using a broker server to leverage third-party resources for failure recovery.

FIG. 20 is an exemplary overall system architecture for callback site optimization with callback time optimization and preferred agent availability re-routing.

FIG. 21 is a flowchart describing an exemplary method for callback site optimization with callback time optimization and preferred agent availability re-routing.

FIG. 22 is an exemplary method diagram illustrating a pacing algorithm for callback site optimization with callback time optimization and preferred agent availability re-routing.

FIG. 23 is a block diagram illustrating an exemplary architecture of a system for callback management with alternate site routing and context-aware callback pacing.

FIG. 24 is an exemplary method diagram illustrating a context-aware pacing algorithm for callback site optimization with callback time optimization and preferred agent availability re-routing.

FIG. 25 is a block diagram illustrating an exemplary hardware architecture of a computing device.

FIG. 26 is a block diagram illustrating an exemplary logical architecture for a client device.

FIG. 27 is a block diagram showing an exemplary architectural arrangement of clients, servers, and external services.

FIG. 28 is another block diagram illustrating an exemplary hardware architecture of a computing device.

### DETAILED DESCRIPTION

The inventor has conceived, and reduced to practice, a system and method for optimizing callback times to increase the success rate of callbacks while managing overflow of calls to alternate sites when callbacks are unsuccessful. The system and method use a context-aware pacing algorithm to determine when callbacks are likely to be successful from a preferred contact site, routing to alternate callback sites when callbacks are unsuccessful, and preferences for re-routing back to the preferred site when a callback is successful and the agent with whom the caller has interacted previously is available.

Large volumes of caller traffic at a contact center may cause long queues of callback requests. While callback queues reduce the burden on callers by not requiring them to wait on hold, callback queues present other problems such as failed callback dialing attempts, unanswered callbacks, and dropped calls during callbacks. These problems may increase the time between successful callback attempts, which can be a burden on contact center resources.

One existing solution to the burden caused by repeated callbacks is the use of alternate contact sites from which callback attempts can be made. Using alternate contact sites to make callback attempts can potentially increase the number of callback attempts possible without burdening the primary contact center site. However, routing inefficiencies may cause alternate contact sites to go underutilized, reducing their effectiveness. Further, routing of callbacks to alternate contact sites does not solve the problems inherent in use of callback queues. Callback problems such as those noted above (failed callback dialing attempts, unanswered callbacks, dropped calls, etc.) may cause the caller to be placed back into the callback queue at the alternate contact site in the same manner as at the primary contact center.

Further, routing to alternate contact sites may cause discontinuity in caller/agent relations in cases where there have been previous contacts between a particular caller and a particular agent. To solve this problem of caller/agent relationship discontinuity, previous interactions between a particular caller and a particular agent may be tracked. When a call is routed to an alternate contact site for further callback attempts, a successful callback attempt to the particular caller may trigger a secondary check for the availability of the particular agent. If the agent is immediately available, the call may be routed back to the particular agent at the preferred contact site instead of being handled by an agent at the alternate callback site. If the agent will be available shortly, the caller may be notified that the particular agent with whom he or she has interacted will be available shortly, and may be given the opportunity to wait on hold until that particular agent is available. If the agent is not available or the caller has decided not to wait for that particular agent, the call can be handled by an agent at the alternate contact site.

The system and method allow for the consideration of customer context, sentiment, and patience when determining timing for a callback and subsequent placement in a callback queue. Context data may be obtained, computed, and/or derived and used in conjunction with a user's predicted likelihood to answer to make enhanced predictions for scheduling callbacks. Context content may be sourced from a user's computing device such as from applications operating on the computing device, call logs, contacts lists, user schedules, and a plurality of external sources such as social media servers. Analyses can be performed on this type information to produce context content data which can be used as an input into a pacing algorithm to determine optimal timing for callbacks.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

“Callback” as used herein refers to an instance of an individual being contacted after their initial contact was unsuccessful. For instance, if a first user calls a second user on a telephone, but the second user does not receive their call for one of numerous reasons including turning off their phone or simply not picking up, the second user may then place a callback to the first user once they realize they missed their call. This callback concept applies equally to many forms of interaction that need not be restricted to telephone calls, for example including (but not limited to) voice calls over a telephone line, video calls over a network connection, or live text-based chat such as web chat or short message service (SMS) texting. While a callback (and various associated components, methods, and operations taught herein) may also be used with an email communication despite the inherently asynchronous nature of email (participants may read and reply to emails at any time, and need not be interacting at the same time or while other participants are online or available), the preferred usage as taught herein refers to synchronous communication (that is, communication where participants are interacting at the same time, as with a phone call or chat conversation).

“Callback object” as used herein means a data object representing callback data, such as the identities and call information for a first and second user, the parameters for a callback including what time it shall be performed, and any other relevant data for a callback to be completed based on the data held by the callback object.

“Latency period” as used herein refers to the period of time between when a Callback Object is created and the desired Callback is initiated, for example, if a callback object is created and scheduled for a time five hours from the creation of the object, and the callback initiates on-time in five hours, the latency period is equal to the five hours between the callback object creation and the callback initiation.

“Brand” as used herein means a possible third-party service or device that may hold a specific identity, such as a specific MAC address, IP address, a username or secret key which can be sent to a cloud callback system for identification, or other manner of identifiable device or service that may connect with the system. Connected systems or services may include a Private Branch Exchange (“PBX”), call router, chat server which may include text or voice chat data, a Customer Relationship Management (“CRM”) server, an Automatic Call Distributor (“ACD”), or a Session Initiation Protocol (“SIP”) server.

“Fulfill” as used herein means to execute a callback call from an agent to a client, without unexpected drops of the line of communication, and without the client requesting or being assigned to a queue.

“Agent” as used herein is a person which is at a location which contains an on-premise callback system.

“Client” as used herein means a person which is on the receiving end of a callback call from an agent, and may also refer to the person which initiated the line of communication with a brand or agent.

“Preferred site” as used herein means the initial contact site which routed the callback request to a queue.

### Conceptual Architecture

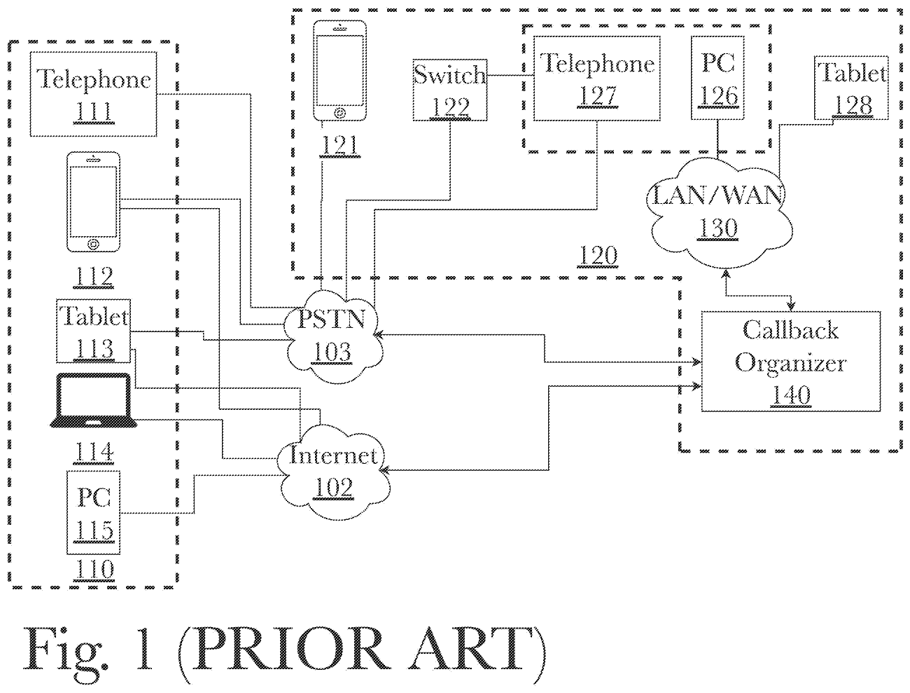

FIG. 1 (PRIOR ART) is a block diagram illustrating an on-premise callback system. A possible plurality of consumer endpoints 110 may be connected to either a Public Switch Telephone Network (“PSTN”) 103 or the Internet 102, further connecting them to an on-premise callback system 120. Such consumer endpoints may include a telephone 111 which connects over a PSTN, a mobile phone 112 capable of connecting over either a PSTN 103 or the Internet 102, a tablet 113 capable of connecting over either a PSTN 103 or the Internet 102, or a laptop 114 or Personal Computer (“PC”) 115 capable of connecting over the Internet 102. Connected to the Internet 102 is a callback organizer 140, which organizes callback data across internet 102 and PSTN 103 connections to consumer endpoints 110 and a local area network or wide area network 130 to further on-premise components. Other on-premise or inter-organizational endpoints may include agent cellular devices 121, an internal telephone switch 122 and telephone 127 which connect to the PSTN 103, a PC 126 or a tablet 128 that may be connected over a LAN or WAN 130. These brand endpoints in an on-premise callback system 120 may be involved in callbacks over the PSTN 103 or internet 102 connections, as organized by a callback organizer 140, which is responsible for all aspects of organizing callback requests including managing and calculating Estimated Wait-Times (EWT), managing agent schedule data, managing consumer queues and the agents logged into those queues, and other typical functions of an on-premise callback system.

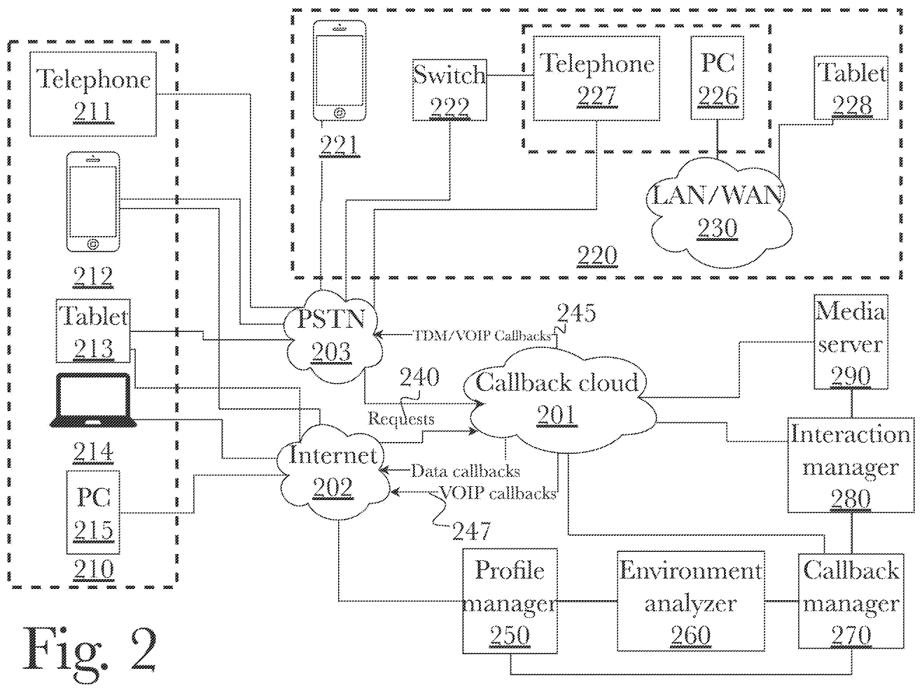

FIG. 2 is a block diagram of a preferred embodiment of the invention, illustrating an exemplary architecture of a system 200 for providing a callback cloud service. According to the embodiment, callback cloud 201 may receive requests 240 via a plurality of communications networks such as a public switched telephone network (PSTN) 203 or the Internet 202. These requests may comprise a variety of communication and interaction types, for example including (but not limited to) voice calls over a telephone line, video calls over a network connection, or live text-based chat such as web chat or short message service (SMS) texting via PSTN 203. Such communications networks may be connected to a plurality of consumer endpoints 210 and enterprise endpoints 220 as illustrated, according to the particular architecture of communication network involved. Exemplary consumer endpoints 210 may include, but are not limited to, traditional telephones 211, cellular telephones 212, mobile tablet computing devices 213, laptop computers 214, or desktop personal computers (PC) 215. Such devices may be connected to respective communications networks via a variety of means, which may include telephone dialers, VOIP telecommunications services, web browser applications, SMS text messaging services, or other telephony or data communications services. It will be appreciated by one having ordinary skill in the art that such means of communication are exemplary, and many alternative means are possible and becoming possible in the art, any of which may be utilized as an element of system 200 according to the invention.

A PSTN 203 or the Internet 202 (and it should be noted that not all alternate connections are shown for the sake of simplicity, for example a desktop PC 226 may communicate via the Internet 202) may be further connected to a plurality of enterprise endpoints 220, which may comprise cellular telephones 221, telephony switch 222, desktop environment 225, internal Local Area Network (LAN) or Wide-Area Network (WAN) 230, and mobile devices such as tablet computing device 228. As illustrated, desktop environment 225 may include both a telephone 227 and a desktop computer 226, which may be used as a network bridge to connect a telephony switch 222 to an internal LAN or WAN 230, such that additional mobile devices such as tablet PC 228 may utilize switch 222 to communicate with PSTN 202. Telephone 227 may be connected to switch 222 or it may be connected directly to PSTN 202. It will be appreciated that the illustrated arrangement is exemplary, and a variety of arrangements that may comprise additional devices known in the art are possible, according to the invention.

Callback cloud 201 may respond to requests 240 received from communications networks with callbacks appropriate to the technology utilized by such networks, such as data or Voice over Internet Protocol (VOIP) callbacks 245, 247 sent to Internet 202, or time-division multiplexing (TDM) such as is commonly used in cellular telephony networks such as the Global System for Mobile Communications (GSM) cellular network commonly used worldwide, or VOIP callbacks to PSTN 203. Data callbacks 247 may be performed over a variety of Internet-enabled communications technologies, such as via e-mail messages, application pop-ups, or Internet Relay Chat (IRC) conversations, and it will be appreciated by one having ordinary skill in the art that a wide variety of such communications technologies are available and may be utilized according to the invention. VOIP callbacks may be made using either, or both, traditional telephony networks such as PSTN 203 or over VOIP networks such as Internet 202, due to the flexibility to the technology involved and the design of such networks. It will be appreciated that such callback methods are exemplary, and that callbacks may be tailored to available communications technologies according to the invention.

A profile manager 250 associated with a callback cloud 201 may receive initial requests to connect to the callback cloud 201, and forward relevant user profile information to a callback manager 270, which may further request environmental context data from an environment analyzer 260. Environmental context data may include (for example, and not limited to) recorded information about when a callback requester or callback recipient may be suspected to be driving or commuting from work, for example, and may be parsed from online profiles or online textual data.

The callback manager 270 centrally manages all callback data, creating a callback object which may be used to manage the data for a particular callback, and communicates with an interaction manager 280 which handles requests to make calls and bridge calls, which go out to a media server 290 which actually makes the calls as requested. In this way, the media server 290 may be altered in the manner in which it makes and bridges calls when directed, but the callback manager 270 does not need to adjust itself, due to going through an intermediary component, the interaction manager 280, as an interface between the two. A media server 290, when directed, may place calls and send messages, emails, or connect voice over IP (“VoIP”) calls and video calls, to users over a PSTN 203 or the Internet 202. Callback manager 270 may work with a user's profile as managed by a profile manager 250, with environmental context from an environment analyzer 260 as well as (if provided) EWT information for any callback recipients (for example, contact center agents with the appropriate skills to address the callback requestor's needs, or online tech support agents to respond to chat requests), to determine an appropriate callback time for the two users (a callback requestor and a callback recipient), interfacing with an interaction manager 280 to physically place and bridge the calls with a media server 290. If a callback is requested, a callback cloud 201 may find an optimal time to bridge a call between the callback requestor and callback recipient, as necessary.

Additionally, callback cloud 201 may receive estimated wait time (EWT) information from an enterprise 220 such as a contact center. This information may be used to estimate the wait time for a caller before reaching an agent (or other destination, such as an automated billing system), and determine whether to offer a callback proactively before the customer has waited for long. EWT information may also be used to select options for a callback being offered, for example to determine availability windows where a customer's callback is most likely to be fulfilled (based on anticipated agent availability at that time), or to offer the customer a callback from another department or location that may have different availability. This enables more detailed and relevant callback offerings by incorporating live performance data from an enterprise, and improves customer satisfaction by saving additional time with preselected recommendations and proactively-offered callbacks.

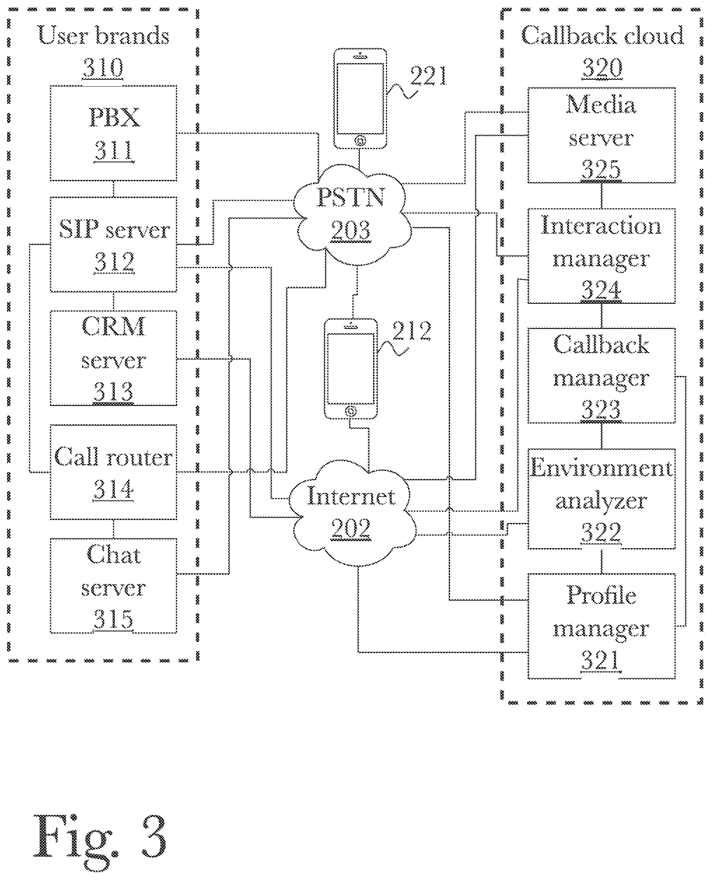

FIG. 3 is a block diagram illustrating an exemplary system architecture for a callback cloud operating over a public switched telephone network and the Internet, and connecting to a variety of other brand devices and services, according to an embodiment. A collection of user brands 310 may be present either singly or in some combination, possibly including a Public Branch Exchange (“PBX”) 311, a Session Initiation Protocol (“SIP”) server 312, a Customer Relationship Management (“CRM”) server 313, a call router 314, or a chat server 315, or some combination of these brands. These brands 310 may communicate over a combination of, or only one of, a Public Switched Telephone Network (“PSTN”) 203, and the Internet 202, to communicate with other devices including a callback cloud 320, a company phone 221, or a personal cellular phone 212. A SIP server 312 is responsible for initiating, maintaining, and terminating sessions of voice, video, and text or other messaging protocols, services, and applications, including handling of PBX 311 phone sessions, CRM server 313 user sessions, and calls forwarded via a call router 314, all of which may be used by a business to facilitate diverse communications requests from a user or users, reachable by phone 221, 212 over either PSTN 203 or the Internet 202. A chat server 315 may be responsible for maintaining one or both of text messaging with a user, and automated voice systems involving technologies such as an Automated Call Distributor (“ACD”), forwarding relevant data to a call router 314 and CRM server 313 for further processing, and a SIP server 312 for generating communications sessions not run over the PSTN 203. Various systems may also be used to monitor their respective interactions (for example, chat session by a chat server 315 or phone calls by an ACD or SIP server 312), to track agent and resource availability for producing EWT estimations.

When a user calls from a mobile device 212 or uses some communication application such as (for example, including but not limited to) SKYPE™ or instant messaging, which may also be available on a laptop or other network endpoint 660, 670 other than a cellular phone 212, they may be forwarded to brands 310 operated by a business in the manner described herein. For example, a cellular phone call my be placed over PSTN 203 before being handled by a call router 314 and generating a session with a SIP server 312, the SIP server creating a session with a callback cloud 320 with a profile manager 321 if the call cannot be completed, resulting in a callback being required. A profile manager 321 in a callback cloud 320 receives initial requests to connect to callback cloud 320, and forwards relevant user profile information to a callback manager 323, which may further request environmental context data from an environment analyzer 322. Environmental context data may include (for example, and not limited to) recorded information about when a callback requester or callback recipient may be suspected to be driving or commuting from work, for example, and may be parsed from online profiles or online textual data, using an environment analyzer 322.

A callback manager 323 centrally manages all callback data, creating a callback object which may be used to manage the data for a particular callback, and communicates with an interaction manager 324 which handles requests to make calls and bridge calls, which go out to a media server 325 which actually makes the calls as requested. In this way, the media server 325 may be altered in the manner in which it makes and bridges calls when directed, but the callback manager 323 does not need to adjust itself, due to going through an intermediary component, the interaction manager 324, as an interface between the two. A media server 325, when directed, may place calls and send messages, emails, or connect voice over IP (“VoIP”) calls and video calls, to users over a PSTN 203 or the Internet 202. Callback manager 323 may work with a user's profile as managed by a profile manager 321, with environmental context from an environment analyzer 322 as well as (if provided) EWT information for any callback recipients (for example, contact center agents with the appropriate skills to address the callback requestor's needs, or online tech support agents to respond to chat requests), to determine an appropriate callback time for the two users (a callback requestor and a callback recipient), interfacing with an interaction manager 324 to physically place and bridge the calls with a media server 325. In this way, a user may communicate with another user on a PBX system 311, or with automated services hosted on a chat server 315, and if they do not successfully place their call or need to be called back by a system, a callback cloud 320 may find an optimal time to bridge a call between the callback requestor and callback recipient, as necessary.

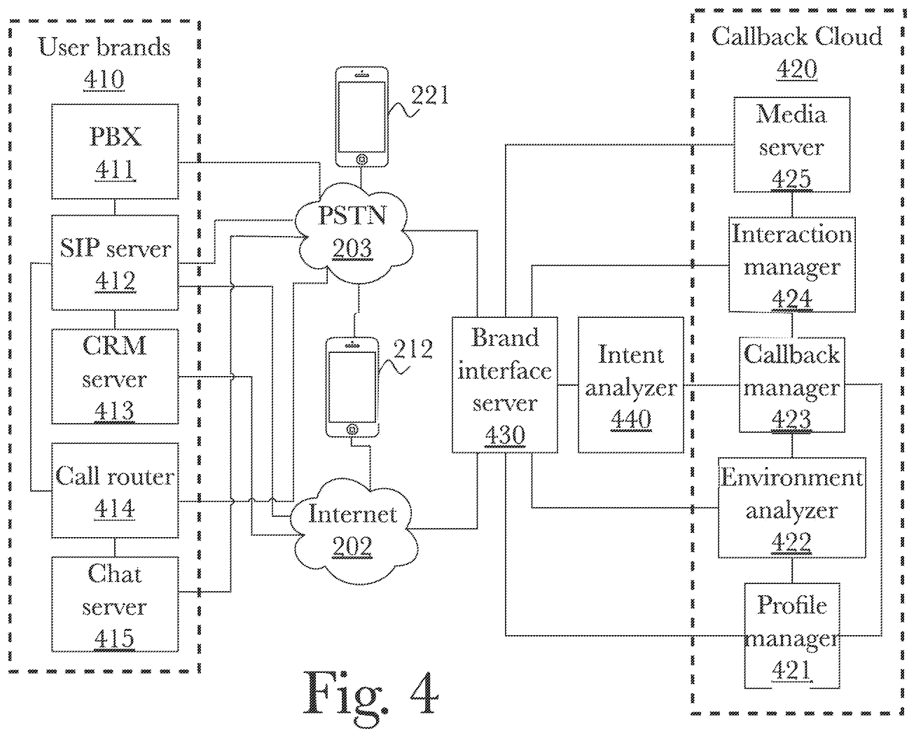

FIG. 4 is a block diagram illustrating an exemplary system architecture for a callback cloud including a brand interface server and intent analyzer, operating over a public switched telephone network and the Internet, and connected to a variety of other brand devices and services, according to an embodiment. According to this embodiment, many user brands 410 are present, including PBX system 411, a SIP server 412, a CRM server 413, a call router 414, and a chat server 415, which may be connected variously to each other as shown, and connected to a PSTN 203 and the Internet 202, which further connect to a cellular phone 212 and a landline 221 or other phone that may not have internet access. Further shown is a callback cloud 420 contains multiple components, including a profile manager 421, environment analyzer 422, callback manager 423, interaction manager 424, and media server 425, which function as described in previous embodiments and, similarly to user brands 410 may be interconnected in various ways as depicted in the diagram, and connected to either a PSTN 203 or the internet 202.

Present in this embodiment is a brand interface server 430, which may expose the identity of, and any relevant API's or functionality for, any of a plurality of connected brands 410, to elements in a callback cloud 420. In this way, elements of a callback cloud 420 may be able to connect to, and interact more directly with, systems and applications operating in a business' infrastructure such as a SIP server 412, which may be interfaced with a profile manager 421 to determine the exact nature of a user's profiles, sessions, and interactions in the system for added precision regarding their possible availability and most importantly, their identity. Also present in this embodiment is an intent analyzer 440, which analyzes spoken words or typed messages from a user that initiated the callback request, to determine their intent for a callback. For example, their intent may be to have an hour-long meeting, which may factor into the decision by a callback cloud 420 to place a call shortly before one or both users may be required to start commuting to or from their workplace. Intent analysis may utilize any combination of text analytics, speech-to-text transcription, audio analysis, facial recognition, expression analysis, posture analysis, or other analysis techniques, and the particular technique or combination of techniques may vary according to such factors as the device type or interaction type (for example, speech-to-text may be used for a voice-only call, while face/expression/posture analysis may be appropriate for a video call), or according to preconfigured settings (that may be global, enterprise-specific, user-specific, device-specific, or any other defined scope).

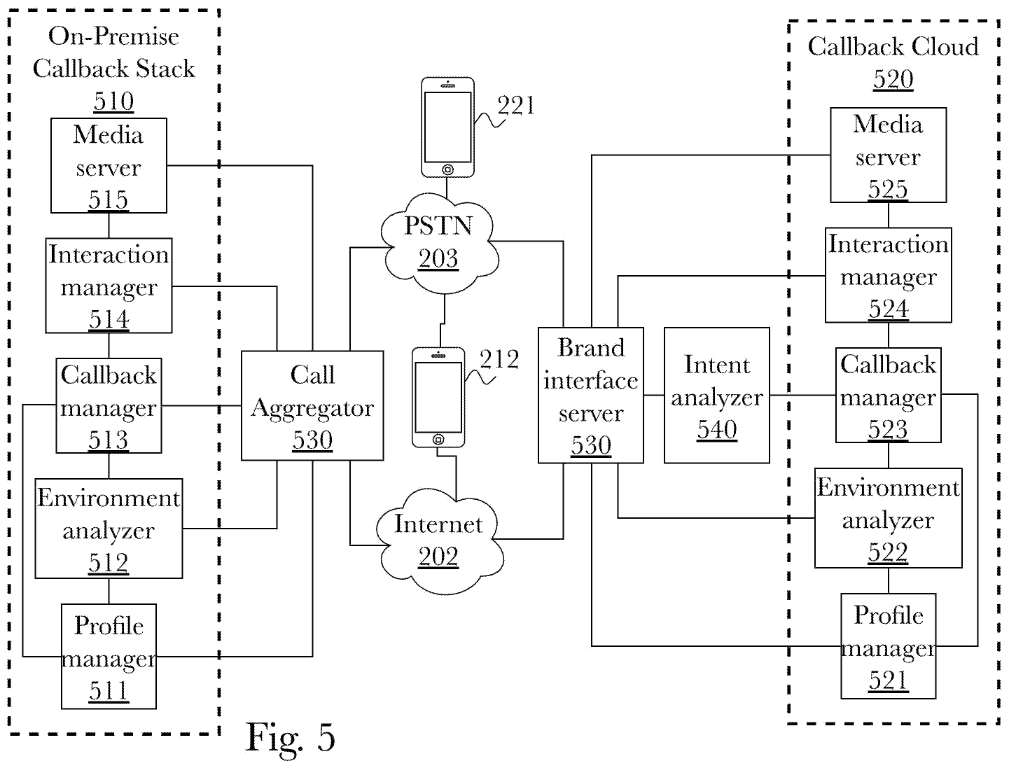

FIG. 5 is a block diagram illustrating an exemplary system architecture for a hybrid callback system operating with a callback cloud and an on-premise callback stack, according to an embodiment. According to this embodiment, an on-premise callback stack 510 is shown, which contains multiple components, including a profile manager 511, environment analyzer 512, callback manager 513, interaction manager 514, and media server 515, which are interconnected in various ways as depicted in the diagram, and connected to a call aggregator 530 which aggregates user calls into queues using data received from an on-premise callback stack 510, and allowing these aggregated and queued calls to then be managed by a callback manager 513. A call aggregator may be connected to either of a PSTN 203 or the internet 202, or it may be connected to both and receive call data from both networks as needed. Further shown is a callback cloud 520 which contains multiple similar components, including a profile manager 521, environment analyzer 522, callback manager 523, interaction manager 524, and media server 525, which function as described in previous embodiments and, similarly to an on-premise callback stack 510 may be interconnected in various ways as depicted in the diagram, and connected to either a PSTN 203 or the internet 202.

Present in this embodiment is a brand interface server 530, which may expose the identity of, and any relevant API's or functionality for, any of a plurality of connected brands or on-premise callback components 510 which may be responsible for operating related brands, to elements in a callback cloud 520. In this way, elements of a callback cloud 520 may be able to connect to, and interact more directly with, systems and applications operating in a business' infrastructure such as a SIP server, which may be interfaced with a profile manager 521 to determine the exact nature of a user's profiles, sessions, and interactions in the system for added precision regarding their possible availability and most importantly, their identity. Also present in this embodiment is an intent analyzer 540, which analyzes spoken words or typed messages from a user that initiated the callback request, to determine their intent for a callback. For example, their intent may be to have an hour-long meeting, which may factor into the decision by a callback cloud 520 to place a call shortly before one or both users may be required to start commuting to or from their workplace. Intent analysis may utilize any combination of text analytics, speech-to-text transcription, audio analysis, facial recognition, expression analysis, posture analysis, or other analysis techniques, and the particular technique or combination of techniques may vary according to such factors as the device type or interaction type (for example, speech-to-text may be used for a voice-only call, while face/expression/posture analysis may be appropriate for a video call), or according to preconfigured settings (that may be global, enterprise-specific, user-specific, device-specific, or any other defined scope).

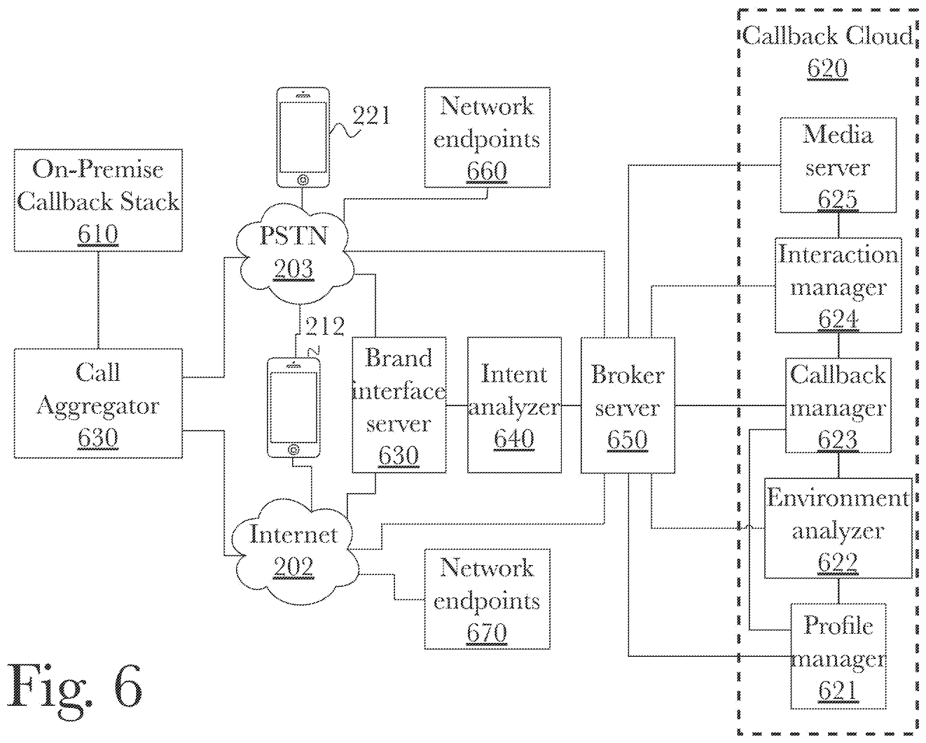

FIG. 6 is a block diagram illustrating an exemplary system architecture for a hybrid callback system operating with a callback cloud and an on-premise callback stack, and a broker server, according to an embodiment. According to this embodiment, an on-premise callback stack 610 is shown, which connects to a call aggregator 630 which aggregates user calls into queues using data received from an on-premise callback stack 610, and allowing these aggregated and queued calls to then be managed by a callback manager 613. The features and connections of the on-premise callback stack 610 are similar to that shown in FIG. 5, 510. A call aggregator may be connected to either of a PSTN 203 or the internet 202, or it may be connected to both and receive call data from both networks as needed. Further shown is a callback cloud 620 which contains multiple components, including a profile manager 621, environment analyzer 622, callback manager 623, interaction manager 624, and media server 625, which function as described in previous embodiments and, similarly to an on-premise callback stack 610 may be interconnected in various ways as depicted in the diagram, and connected to either a PSTN 203 or the internet 202.

Present in this embodiment is a brand interface server 630, which may expose the identity of, and any relevant API's or functionality for, any of a plurality of connected brands or on-premise callback components 610 which may be responsible for operating related brands, to elements in a callback cloud 620, through the use of an intent analyzer 640 and a broker server 650 to act as an intermediary between a callback cloud 620 and the plurality of other systems or services. In this way, elements of a callback cloud 620 may be able to connect to a broker server 650, and interact more indirectly with systems and applications operating in a business' infrastructure such as a SIP server, which may communicate with a profile manager 621 to determine the exact nature of a user's profiles, sessions, and interactions in the system for added precision regarding their possible availability and most importantly, their identity. A broker server 650 operates as an intermediary between the services and systems of a callback cloud 620 and other external systems or services, such as an intent analyzer 640, PSTN 203, or the Internet 202. Also present in this embodiment is an intent analyzer 640, which analyzes spoken words or typed messages from a user that initiated the callback request, to determine their intent for a callback. For example, their intent may be to have an hour-long meeting, which may factor into the decision by a callback cloud 620 to place a call shortly before one or both users may be required to start commuting to or from their workplace. Intent analysis may utilize any combination of text analytics, speech-to-text transcription, audio analysis, facial recognition, expression analysis, posture analysis, or other analysis techniques, and the particular technique or combination of techniques may vary according to such factors as the device type or interaction type (for example, speech-to-text may be used for a voice-only call, while face/expression/posture analysis may be appropriate for a video call), or according to preconfigured settings (that may be global, enterprise-specific, user-specific, device-specific, or any other defined scope).

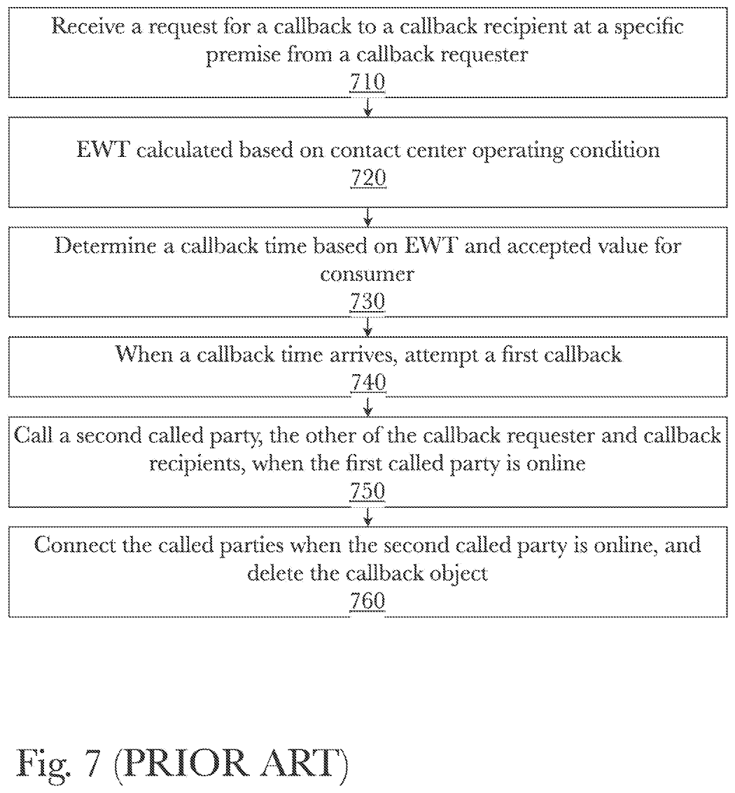

FIG. 7 (PRIOR ART) is a method diagram illustrating steps in the operation of an on-premise callback system. A consumer may initiate a callback request to a brand handled or managed at a premise 710, such as if a consumer were to place a phone call to customer service for a corporation and the contact center or centers were unable to immediately answer their call. An estimated wait time (EWT) is calculated for consumers in the queue based on the condition of the contact center 720, determining a possible callback time based on the EWT and a consumer-accepted time 730, such as calling a consumer back in 10 minutes when an agent at the premise is available and their spot in the queue is reached 740. Regardless of the specific time chosen, a first callback is attempted 740 when the selected time is reached, calling a first party of either the brand agent or the consumer, followed by calling of the second party if and when the first party comes online 750. When both parties are online they are connected together such as bridging the two phones to a single call 760, and any callback object used to manage the callback data is deleted after the successful callback.

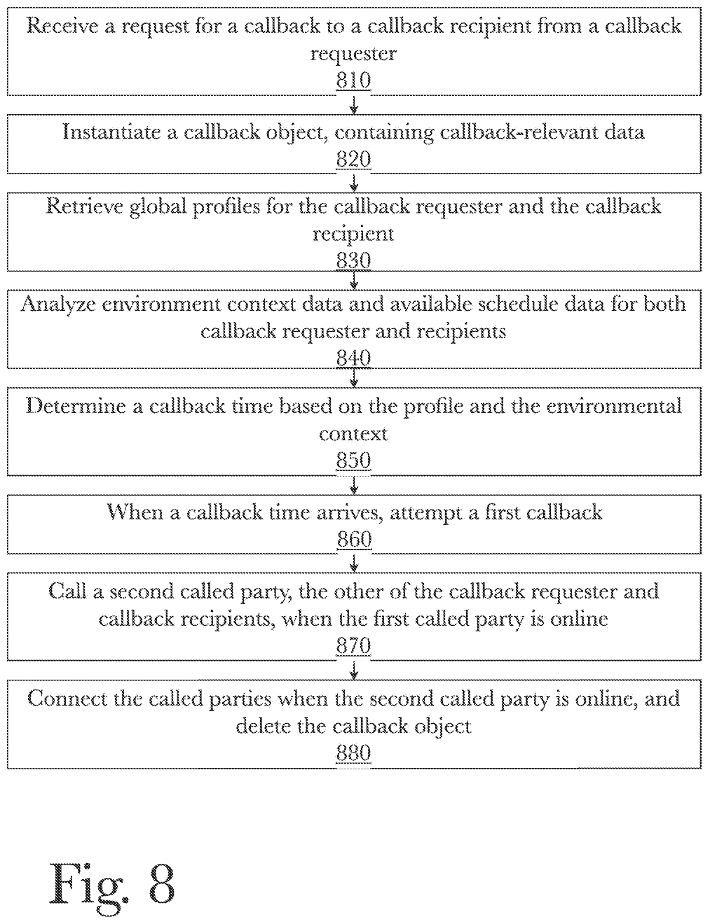

FIG. 8 is a method diagram illustrating the use of a callback cloud for intent-based active callback management, according to an embodiment. According to an embodiment, a callback cloud 320 must receive a request for a callback to a callback recipient, from a callback requester 810. This refers to an individual calling a user of a cloud callback system 320, being unable to connect for any reason, and the system allowing the caller to request a callback, thus becoming the callback requester, from the callback recipient, the person they were initially unable to reach. A callback object is instantiated 820, using a callback manager 323, which is an object with data fields representing the various parts of callback data for a callback requester and callback recipient, and any related information such as what scheduled times may be possible for such a callback to take place. Global profiles may then be retrieved 830 using a profile manager 321 in a cloud callback system, as well as an analysis of environmental context data 840, allowing for the system to determine times when a callback may be possible for a callback requestor and callback recipient both 850. When such a time arrives, a first callback is attempted 860 to the callback requestor or callback recipient, and if this succeeds, a second call is attempted to the second of the callback requestor and callback recipient 870, allowing a media server 325 to bridge the connection when both are online, before deleting the callback object 880.

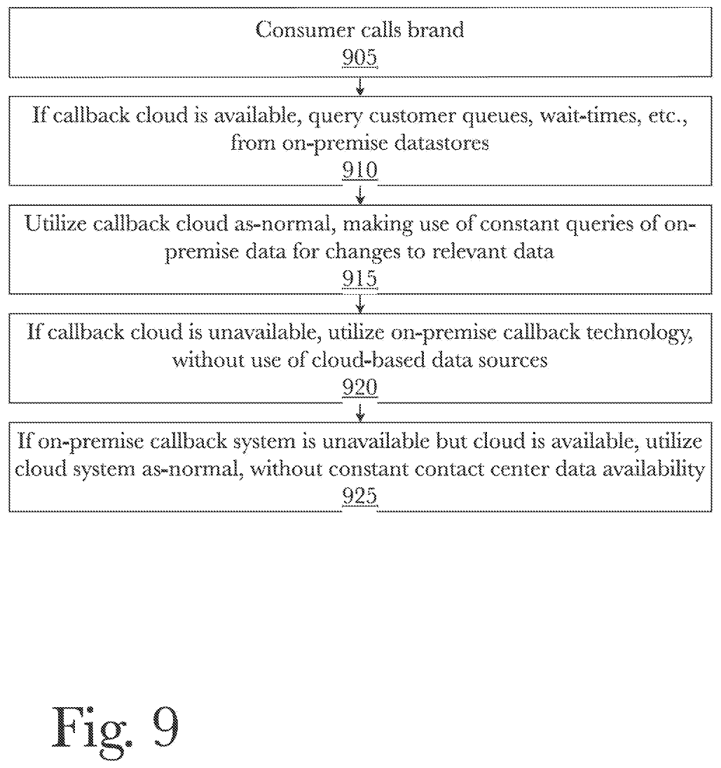

FIG. 9 is a method diagram illustrating the operation of a distributed hybrid callback system architecture utilizing cloud services and on-premise services, according to an embodiment. First, a consumer places a call to a brand 905, resulting in on-premise datastores and services being queried by a callback cloud if such a callback cloud is properly configured and online 910. A callback cloud may be utilized normally to manage consumer queues, calculate EWT's, manage agent statuses and their call lengths and queue membership, and other common callback system functions, with the querying of on-premise datastores and services 915. If a callback cloud is unavailable however, an on-premise callback system may be utilized as described in prior art figures, without use of cloud services 920. If a cloud callback system is available and configured, but on-premise callback services are unavailable, a cloud callback system can utilize last-known data such as last-known EWT's and manage consumer callbacks as normal without being able to query new data from on-premise datastores 925, potentially resulting in slightly less consistent or optimal callback handling initially, but still maintaining the system.

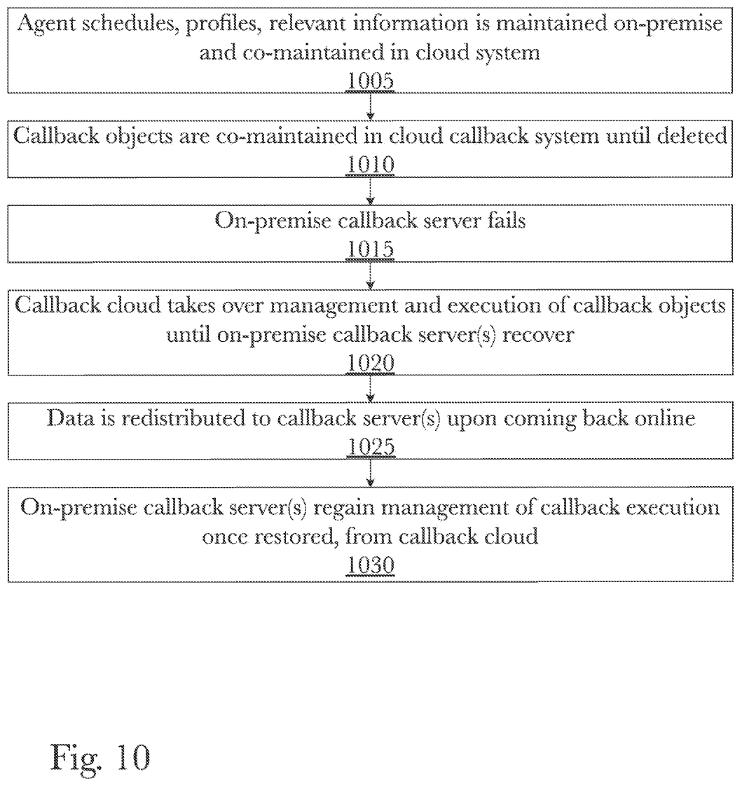

FIG. 10 is a method diagram illustrating the use of callback cloud services to aid in the recovery of an on-premise callback system in the event of a premise callback server failure. Agent data such as schedules and their profiles regarding average call duration are stored on-premise and co-maintained in a cloud callback system 1005. Also co-maintained between a callback cloud and on-premise callback system are callback objects, which hold data regarding a particular callback request including the requester, the time to attempt the callback, and any information regarding the brand or specific agent to perform the callback, if applicable 1010. Should an on-premise callback server fail 1015, a callback cloud may take over management and execution of callback objects until said on-premise callback server recovers 1020, essentially behaving as the new callback system for the contact center. Should a contact center's callback server come back online, data is re-distributed to it from the callback cloud system 1025, with the on-premise server regaining management and execution of callback objects from the callback cloud 1030.

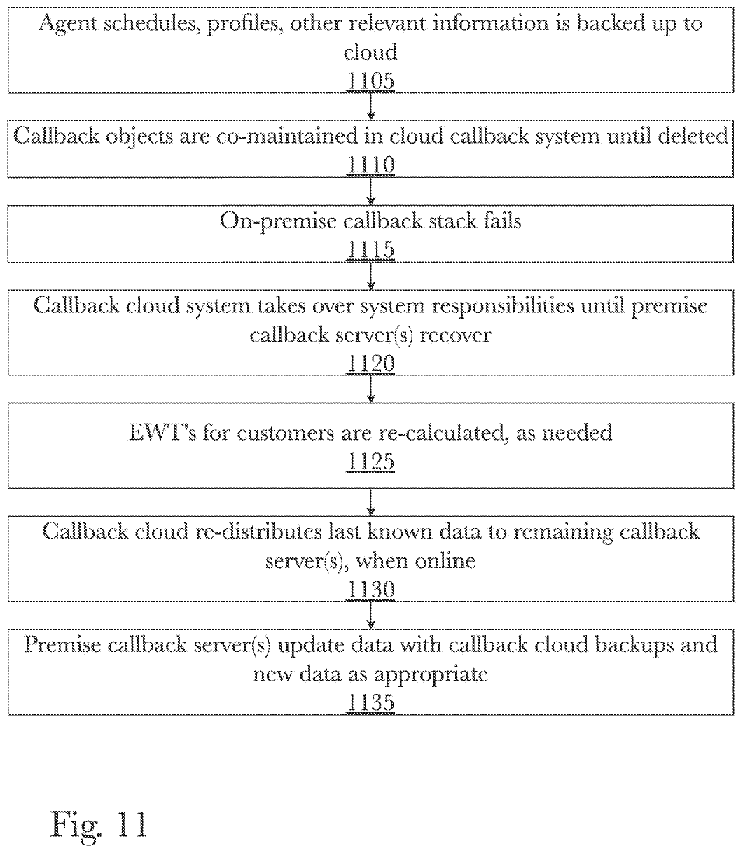

FIG. 11 is a method diagram illustrating the use of callback cloud services to aid in the recovery of an on-premise callback system in the event of a total system failure. Agent data such as schedules and their profiles regarding average call duration are stored on-premise and co-maintained in a cloud callback system 1105. Also co-maintained between a callback cloud and on-premise callback system are callback objects, which hold data regarding a particular callback request including the requester, the time to attempt the callback, and any information regarding the brand or specific agent to perform the callback, if applicable 1110. Should an entire on-premise callback stack fail 1115, a callback cloud may take over management and execution of all callback-related activities including callback execution, EWT calculation 1125, and more 1120, until said on-premise callback stack recovers 1130, essentially behaving as the new callback system for the contact center. Should a contact center's callback stack come back online, data is re-distributed to it from the callback cloud system 1130, with the on-premise server regaining management of callback systems and updating their data from the callback cloud's data as appropriate 1135.

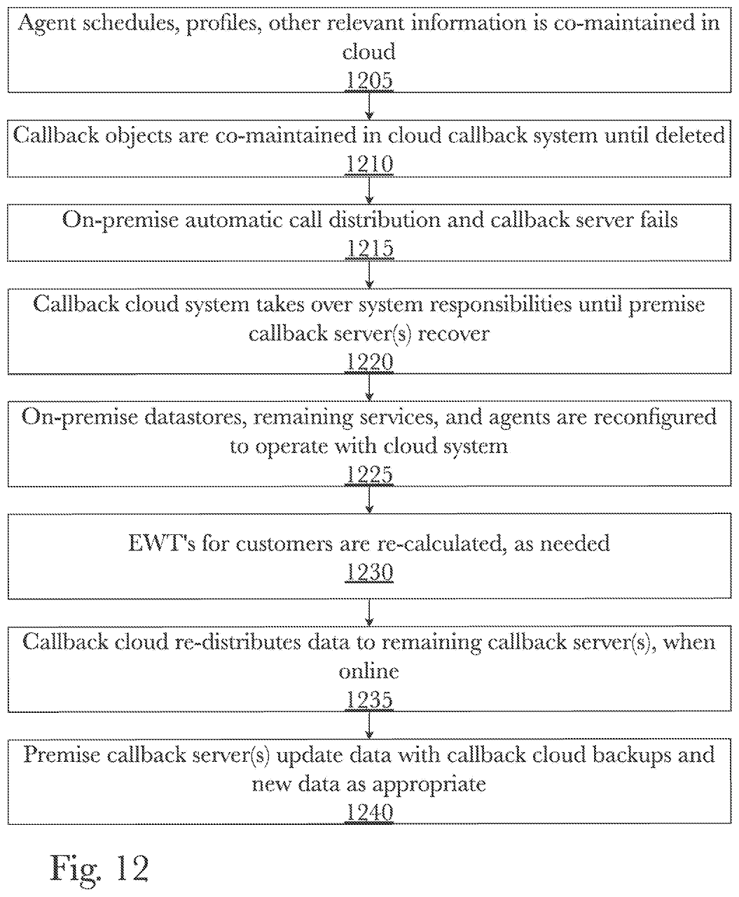

FIG. 12 is a method diagram illustrating the use of callback cloud services to aid in the recovery of an on-premise callback system in the event of a premise automatic call distribution and callback server failure. Agent data such as schedules and their profiles regarding average call duration are stored on-premise and co-maintained in a cloud callback system 1205. Also co-maintained between a callback cloud and on-premise callback system are callback objects, which hold data regarding a particular callback request including the requester, the time to attempt the callback, and any information regarding the brand or specific agent to perform the callback, if applicable 1210. Should an on-premise Automatic Call Distribution (ACD) system and callback server fail 1215, a callback cloud may take over management and execution of call distribution and callback-related activities as necessary 1220, with on-site agents interfacing with cloud services for example through a web-browser 1225 and with remaining on-site resources being made available to the cloud infrastructure as needed such as for the purposes of recalculating consumer EWT's 1230, until the on-premise callback stack recovers, essentially behaving as the new callback system for the contact center. Should a contact center's callback stack come back online, data is re-distributed to it from the callback cloud system 1235, with the on-premise server regaining management of callback systems and updating their data from the callback cloud's data as appropriate 1240.

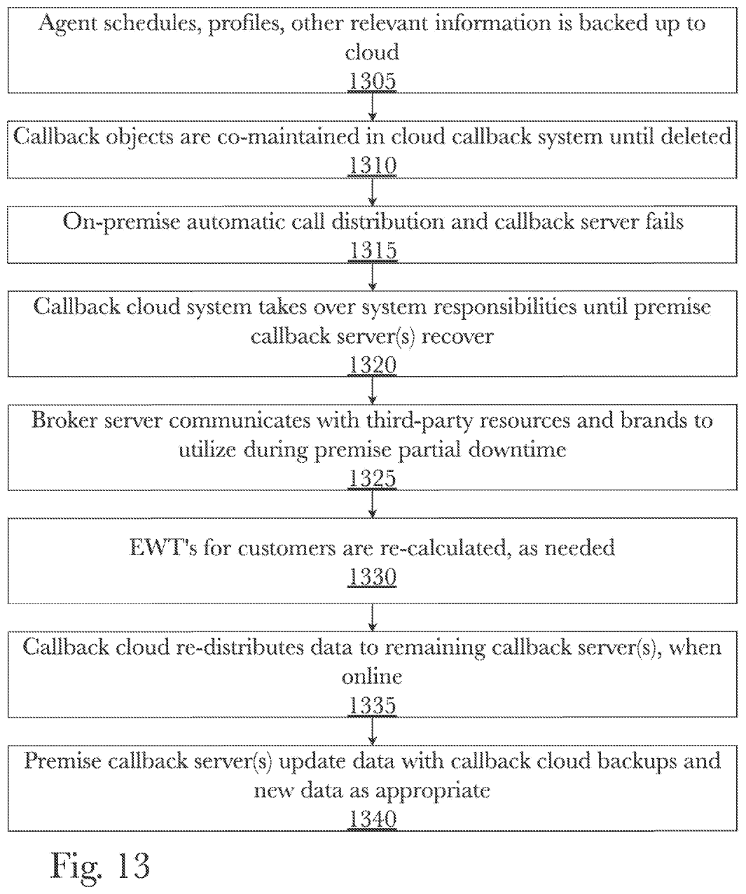

FIG. 13 is a method diagram illustrating the use of callback cloud services to aid in the recovery of an on-premise callback system in the event of a partial system failure, using a broker server to leverage third-party resources for failure recovery. Agent data such as schedules and their profiles regarding average call duration are stored on-premise and co-maintained in a cloud callback system 1305. Also co-maintained between a callback cloud and on-premise callback system are callback objects, which hold data regarding a particular callback request including the requester, the time to attempt the callback, and any information regarding the brand or specific agent to perform the callback, if applicable 1310. Should an on-premise Automatic Call Distribution (ACD) system and callback server fail 1315, a callback cloud may take over management and execution of call distribution and callback-related activities as necessary 1320, with a broker server interfacing with third-party services such as other contact centers to leverage other resources to manage the load during the premise downtime 1325. Consumer EWT is recalculated if needed 1330, and should a contact center's callback stack come back online, data is re-distributed to it from the callback cloud system 1335, with the on-premise server regaining management of callback systems and updating their data from the callback cloud's data as appropriate 1340.

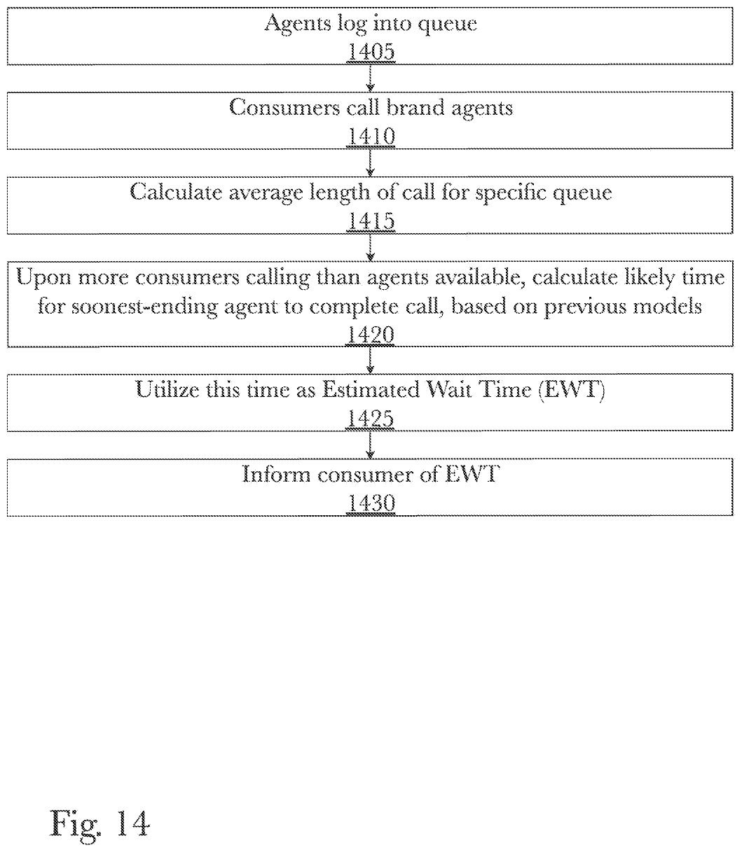

FIG. 14 is a method diagram illustrating calculation and recalculation of an estimated wait-time (EWT) for a distributed callback system. An agent may log into a queue or be assigned automatically to a queue by a callback manager or call aggregator 1405, allowing consumers to call or open communications with a brand's agents 1410. An average call length for each queue is calculated 1415 utilizing branching averages, for example most calls may be calculated to take 4 minutes, but a call that has already progressed to 3 minutes may be calculated to have a 70% chance of reaching at least 5 minutes in length. Upon more consumers than agents becoming available, or any change in the amount of available agents or consumers in the queue, calculate the time based on these averages that the next available agent will be free to engage in a call with the consumer 1420. This is utilized as the Estimated Wait Time (EWT) for a consumer 1425, and a consumer may be informed of the EWT for callback purposes 1430.

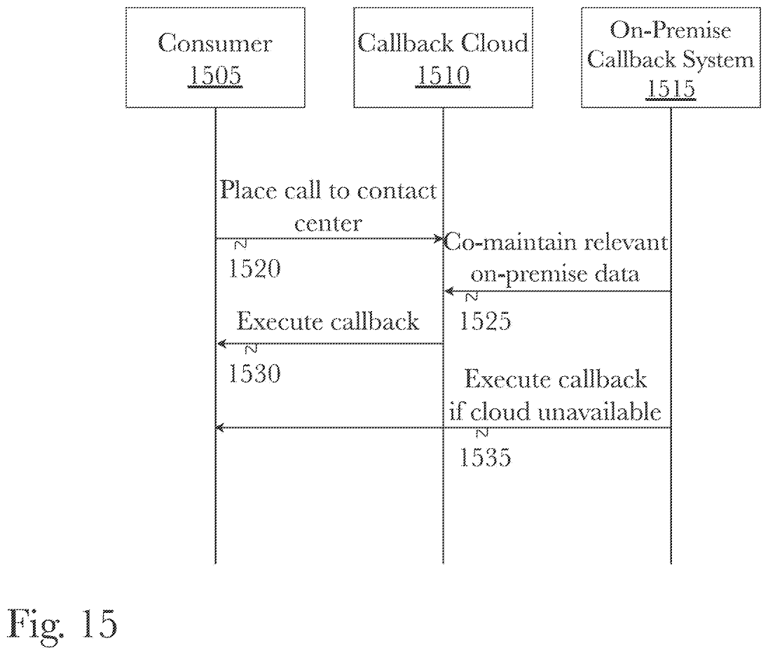

FIG. 15 is a message flow diagram illustrating the operation of a distributed hybrid callback system architecture utilizing cloud services and on-premise services, according to an embodiment. A consumer 1505, callback cloud 1510, and on-premise callback system 1515 are the principle actors in data transmissions, with specific components of a callback cloud 1510 or on-premise callback system 1515 handling data internally to the respective systems, and a consumer 1505 potentially using one of many common endpoints such as a cellphone, landline phone, PC, tablet, or laptop. A consumer 1505 may place a call from one such endpoint, to a contact center 1520, which may be received by a callback cloud 1510 that is online and managing callback data for a given premise callback system 1515. An on-premise callback system 1515 may co-maintain data including average call times for certain queues, agent availability, agent schedules, and more, with a callback cloud 1525, allowing a callback cloud to execute a callback 1530 to a consumer 1505, connecting agents and consumers with said callbacks as necessary. If a callback cloud is unavailable, an on-premise callback system instead executes the callback 1535, the callback object being used to attempt to open communications with the consumer 1505 and an on-premise agent.

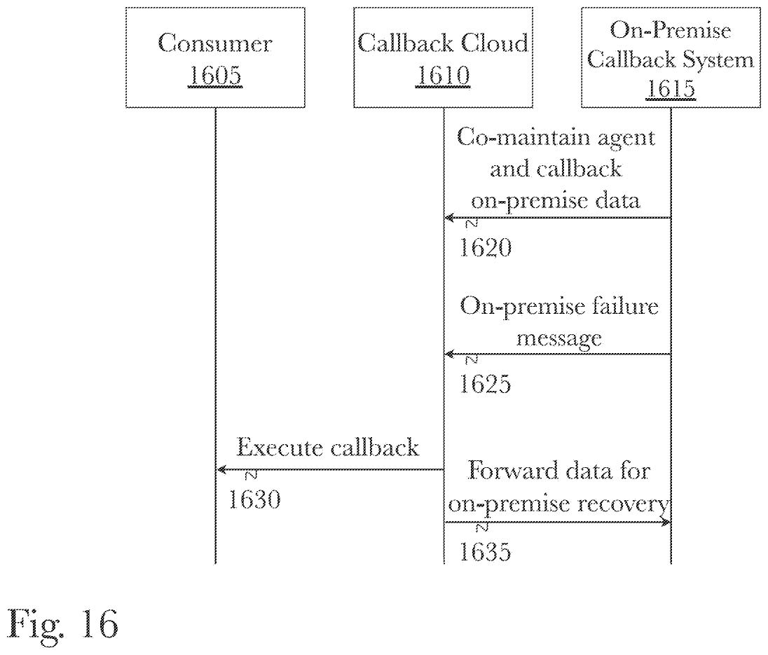

FIG. 16 is a message flow diagram illustrating the use of callback cloud services to aid in the recovery of an on-premise callback system in the event of a premise callback server failure. A consumer 1605, callback cloud 1610, and on-premise callback system 1615 are the principle actors in data transmissions, with specific components of a callback cloud 1610 or on-premise callback system 1615 handling data internally to the respective systems, and a consumer 1605 potentially using one of many common endpoints such as a cellphone, landline phone, PC, tablet, or laptop. An on-premise callback system 1615 may continuously co-maintain data including average call times for certain queues, agent availability, agent schedules, and more, with a callback cloud 1620, before a premise callback server may go offline and be unable to execute callbacks to consumers. In such an event, an on-premise failure message 1625 is sent to a callback cloud 1610, informing a callback cloud to execute any consumer callback requests 1630 to a consumer 1605, connecting agents and consumers with said callbacks as necessary. In such an event, the callback cloud may execute customer callbacks using the previously co-maintained data 1635, the callback object being used to attempt to open communications with the consumer 1605 and an on-premise agent. In the event of an on-premise callback server coming back online, current data regarding the brand and on-premise callback data is forwarded back to a premise callback system 1635, for example to update the server with data on completed and yet-to-complete callback requests.

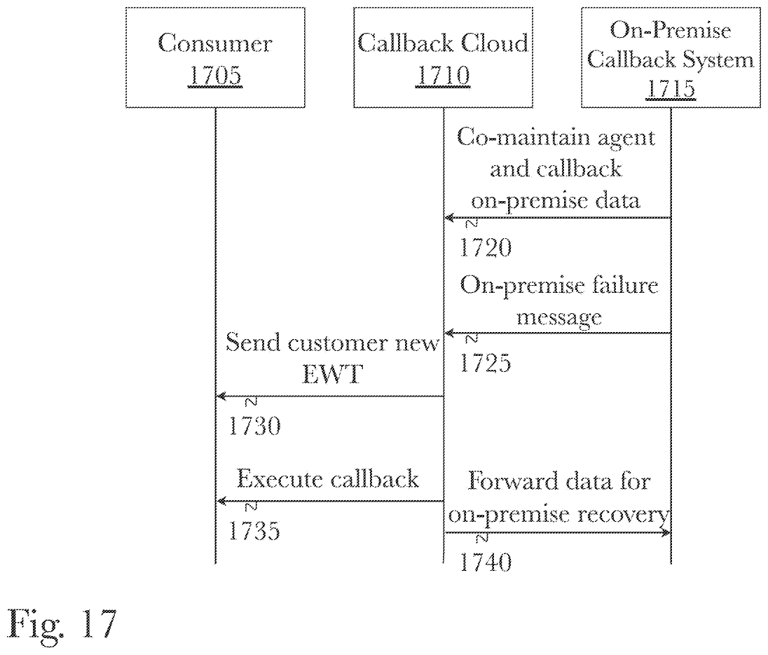

FIG. 17 is a message flow diagram illustrating the use of callback cloud services to aid in the recovery of an on-premise callback system in the event of a total system failure. A consumer 1705, callback cloud 1710, and on-premise callback system 1715 are the principle actors in data transmissions, with specific components of a callback cloud 1710 or on-premise callback system 1715 handling data internally to the respective systems, and a consumer 1705 potentially using one of many common endpoints such as a cellphone, landline phone, PC, tablet, or laptop. An on-premise callback system 1715 may continuously co-maintain data including average call times for certain queues, agent availability, agent schedules, and more, with a callback cloud 1720, before total on-premise callback system failure, such as by a power outage affecting their callback system equipment and services. In such an event, an on-premise failure message 1725 is sent to a callback cloud 1710, informing a callback cloud to first re-calculate and send customer Estimated Wait Times (“EWT”) for customers 1730, since call distribution has been interrupted and must now be accomplished by the cloud service. In such an event, the callback cloud may execute customer callbacks using the previously co-maintained data 1735, the callback object being used to attempt to open communications with the consumer 1705 and an on-premise agent. In the event of an on-premise callback server coming back online, current data regarding the brand and on-premise callback data is forwarded back to a premise callback system 1740, for example to update the server with data on completed and yet-to-complete callback requests.

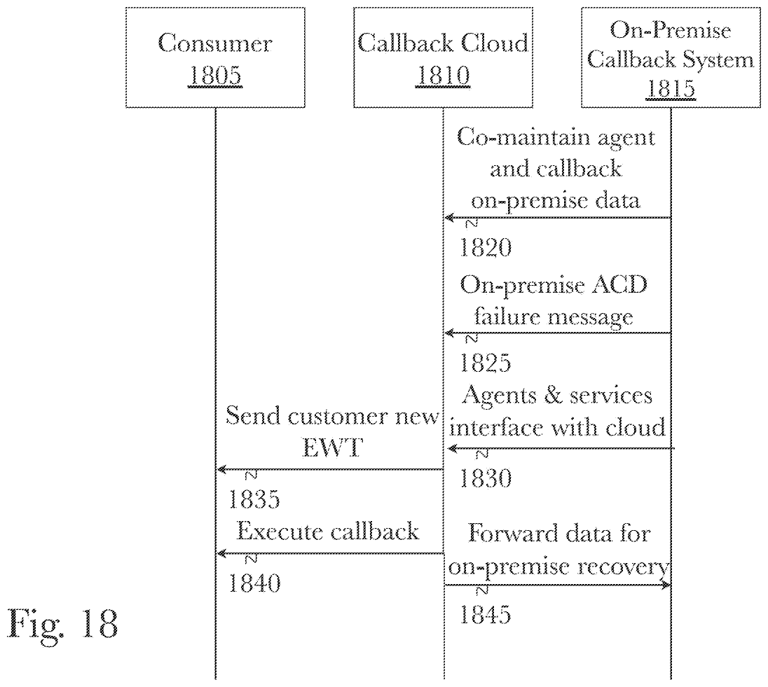

FIG. 18 is a message flow diagram illustrating the use of callback cloud services to aid in the recovery of an on-premise callback system in the event of a premise automatic call distribution and callback server failure. A consumer 1805, callback cloud 1810, and on-premise callback system 1815 are the principle actors in data transmissions, with specific components of a callback cloud 1810 or on-premise callback system 1815 handling data internally to the respective systems, and a consumer 1805 potentially using one of many common endpoints such as a cellphone, landline phone, PC, tablet, or laptop. An on-premise callback system 1815 may continuously co-maintain data including average call times for certain queues, agent availability, agent schedules, and more, with a callback cloud 1820, before on-premise Automatic Call Distribution (“ACD”) and callback servers may go offline and be unable to execute callbacks to consumers or adequately manage incoming calls. In such an event, an on-premise failure message 1825 is sent to a callback cloud 1810, informing a callback cloud to first re-calculate and send customer Estimated Wait Times (“EWT”) for customers 1835, since call distribution has been interrupted and must now be accomplished by the cloud service. In the meantime, agents and services continue to interface with the cloud 1830. In such an event, the callback cloud may execute customer callbacks using the previously co-maintained data 1840, the callback object being used to attempt to open communications with the consumer 1805 and an on-premise agent. In the event of an on-premise callback server coming back online, current data regarding the brand and on-premise callback data is forwarded back to a premise callback system 1845, for example to update the server with data on completed and yet-to-complete callback requests.

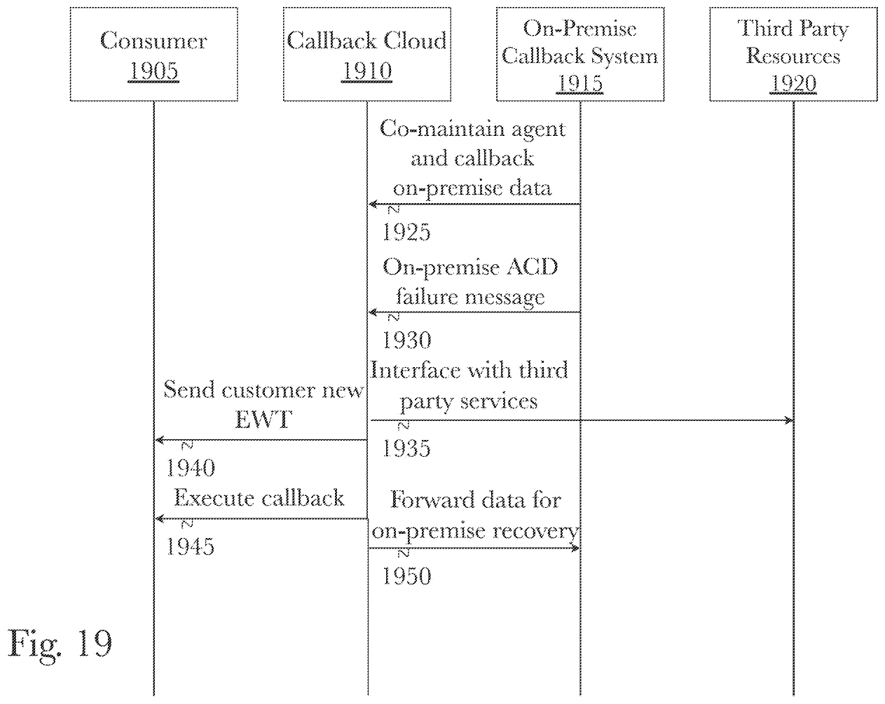

FIG. 19 is a message flow diagram illustrating the use of callback cloud services to aid in the recovery of an on-premise callback system in the event of a partial system failure, using a broker server to leverage third-party resources for failure recovery. A consumer 1905, callback cloud 1910, and on-premise callback system 1915 are the principle actors in data transmissions, with specific components of a callback cloud 1910 or on-premise callback system 1915 handling data internally to the respective systems, and a consumer 1905 potentially using one of many common endpoints such as a cellphone, landline phone, PC, tablet, or laptop. An on-premise callback system 1915 may continuously co-maintain data including average call times for certain queues, agent availability, agent schedules, and more, with a callback cloud 1920, before on-premise Automatic Call Distribution (“ACD”) and callback servers may go offline and be unable to execute callbacks to consumers or adequately manage incoming calls 1930. In such an event, an on-premise failure message 1925 is sent to a callback cloud 1910, informing a callback cloud to first re-calculate and send customer Estimated Wait Times (“EWT”) for customers 1940, since call distribution has been interrupted and must now be accomplished by the cloud service. In such an event, the callback cloud may execute customer callbacks using the previously co-maintained data 1945, the callback object being used to attempt to open communications with the consumer 1905 and an on-premise agent. In the event of an on-premise callback server coming back online, current data regarding the brand and on-premise callback data is forwarded back to a premise callback system 1950, for example to update the server with data on completed and yet-to-complete callback requests.

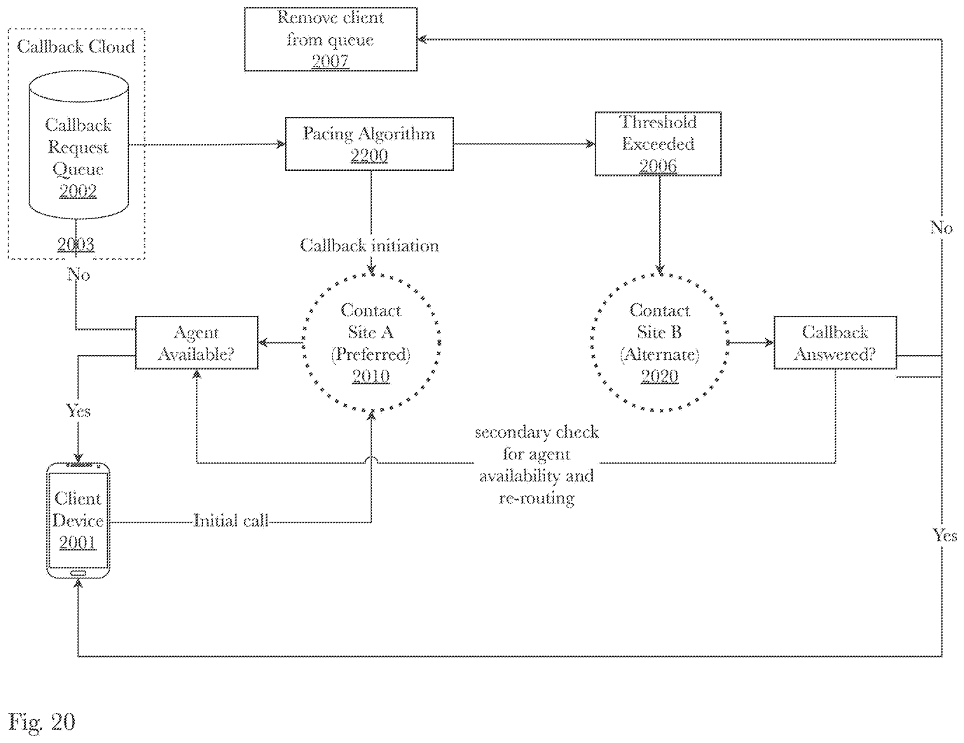

FIG. 20 is an exemplary overall system architecture for callback site optimization with callback time optimization and preferred agent availability re-routing.

A caller attempts an initial communication request to a company via a client device 2001, which is routed to a preferred contact site 2010. The communication may be made using a VOIP (Voice over Internet Protocol) connection, TDM (Time Division multiplexing) or any other form of communication of which may not be limited to exclusively voice (such as SMS, text chat, video conferencing, etc.). In cases where the caller has previously interacted with a particular agent at the preferred contact site 2010, that agent's availability may be checked first, and the caller may be preferentially connected with that agent before the call is otherwise routed. If the particular agent is not available, the call may be routed to another agent. If no agents are available, the caller is asked whether he or she would like to be called back. If the caller agrees to a callback, the call is routed to a callback queue 2002 which may be a cloud-based system 2003. In some cases, the caller may be requested to indicate a preferred callback time. In some cases, the caller's history of communications may be stored in a database associated with the callback queue 2002, and may include information such as the caller's initial call times, attempted callback times, and the percentage of callbacks that were answered by the caller at the attempted callback times.

The caller's location in the callback queue 2002 is dynamically adjusted by a pacing algorithm 2200, which assigns a location in the queue according to the likelihood of success of a callback as determined by several factors, a non-limiting list of which includes the caller's preferred times for callbacks, the caller's history of communications, a preferred agent's availability, the availability of other agents, and external events which may affect callback success (e.g., holidays, sporting events, extreme weather, etc.). Prior to initiation of a callback according to the caller's location in the queue as determined by the pacing algorithm, agent availability may be checked including the availability of a preferred agent. The pacing algorithm may retrieve information pertaining to the customer or agent (or both) for determining an optimal time of attempting the callback fulfillment attempt. For example, a non-limiting list of information about callers that may be stored and retrieved includes the caller's phone number, preferred times for callbacks, historical times of callbacks to the caller, historical percentages of answers by the caller at certain times, statistical data about individuals and groups similar to the caller, etc. In some embodiments, the pacing algorithm may also be used at the alternate contact site 2020 to determine callback times.

Each time a callback attempt is made, a callback counter may be updated. After a threshold number of unsuccessful callbacks is made 2006, the call may be routed to an alternate contact site 2020 in order to offload some of the call and/or callback volume from the preferred contact site 2010, thus leaving the preferred contact site 2010 with more resources to handle callbacks that are more likely to be successful. Information used to determine the threshold 2006 may include but is not limited to: the number of agents available at the site, the type of communication being used, the number of clients currently in the callback request queue, and the volume of callbacks at the alternate contact site 2020. In some embodiments, the threshold may also be used at the alternate contact site 2020 to determine when to route the call for handling at additional alternate contact sites (now shown), which may in some embodiments be considered lower-tier contact sites, such that a hierarchy of alternate contact sites is established.

At the alternate contact site 2020, callbacks may be processed in a manner similar to that of the preferred contact site 2010, including use of a callback queue 2002, a pacing algorithm 2200, and in some embodiments a threshold 2006 for callback failures which causes the callback handling to be routed to additional alternate sites (not shown). In this embodiment, in order to attempt to maintain consistency of communications between the caller and a preferred agent, a secondary check for that particular agent's availability may be made immediately prior to making each callback attempt. At the alternate contact site 2020, a determination may be made to remove the caller from the queue 2007 after a pre-determined number of failed callback attempts, which pre-determined number may be the same as the threshold 2006 of failed callback attempts for the alternate contact site 2020.

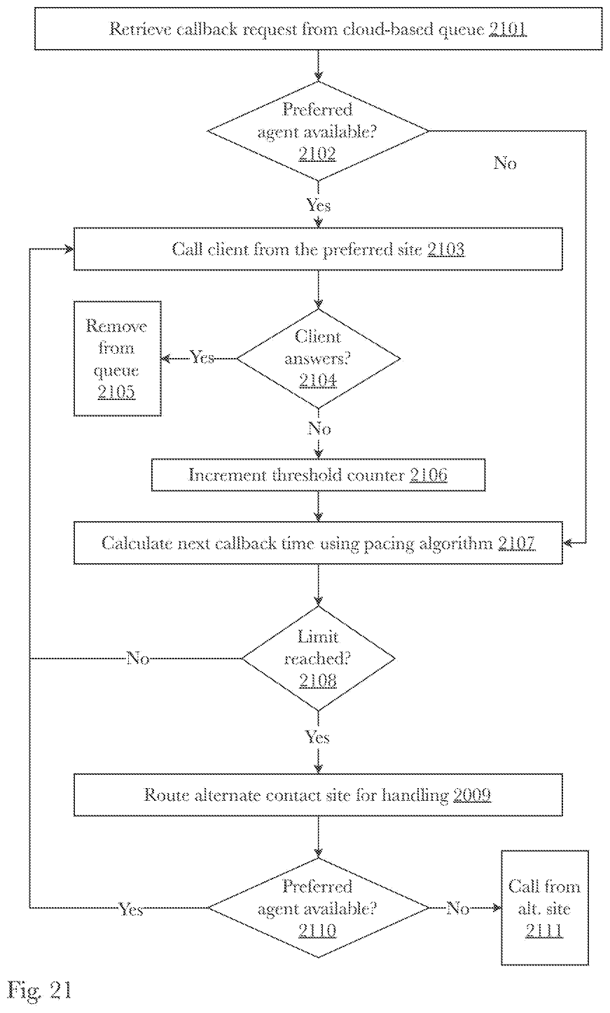

FIG. 21 is a flowchart describing an exemplary method for callback site optimization with callback time optimization and preferred agent availability re-routing. In a first step, a callback request is retrieved from the callback queue 2101, which queue may be cloud-based in implementation. If a preferred agent is associated with the callback request (such as when there has been a prior communication between the caller and a particular agent), a check is made to see whether that preferred agent is available 2102. If so, a callback attempt is made from the preferred contact site 2103. If the preferred agent is not available, the next callback time is calculated using a pacing algorithm 2107. If the caller answers 2104 a callback attempt, the caller is then removed from the queue 2105 as the callback has been successful. If the caller does not answer 2104, a failed callback attempt counter is incremented 2106 and the next callback time is calculated using a pacing algorithm 2107. A check is made to determine whether the number of failed callback attempts as indicated by the counter exceeds a limit or threshold 2108. If the threshold is not exceeded, further callback attempts are made from the preferred site 2103. If the threshold is exceeded, callback handling is routed to an alternate contact site 2009. When the callback comes up in the queue at the alternate contact site, a secondary check may be made to determine whether the preferred agent is now available at the preferred site 2110. If the agent is available, the call is routed back to the preferred site 2103 for handling by the preferred agent. If the preferred agent is not available, the callback is made from the alternate contact site 2111.

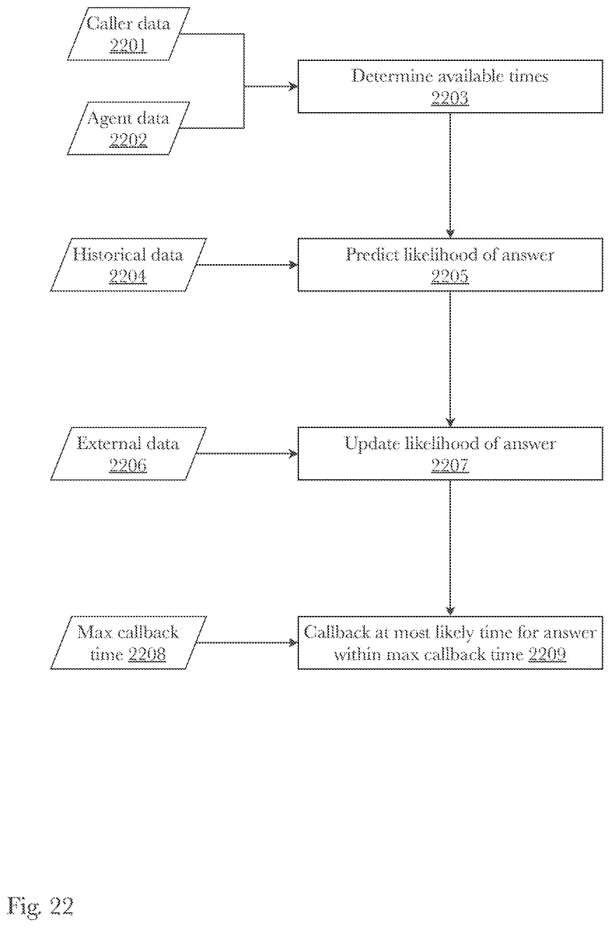

FIG. 22 is an exemplary method diagram illustrating a pacing algorithm for callback site optimization with callback time optimization and preferred agent availability re-routing. As a first step caller data 2201 and agent data 2202 are used to determine callback times at which both the caller and agent are available 2203. The agent data will generally be known according to the agent's work schedule, but may also include times of the day that are particularly busy or free for the agent or other such detailed information. The caller data may include indications of availability by the caller (such as in response to queries about convenient callback times) and/or stored histories of communications with the caller (such as previous times at which callbacks to the caller have been successful). At a second step, a likelihood of an answer by the caller at certain times may be predicted 2205 based on historical information about the caller 2204 (such as a history of previous callback times, a likelihood of the caller answering at certain times, etc.). At a third step, the predicted likelihood of an answer may be updated 2207 based on external data 2206 (such as holidays, sporting events, extreme weather, etc.). For example, on holidays, people will be both more likely to be available and answer a call, whereas during periods of extreme weather, people may be available, but less likely to answer a call. If information is known about the caller (e.g., that he or she is a fan of a particular sports team), that information may be used to adjust the likelihood that the caller will answer a callback (e.g., if that particular sports team is playing a game at the projected callback time). Finally, callbacks after a certain number of hours or days are likely to be perceived as non-responsive, so a maximum callback time period can be established 2208, and a callback may be scheduled for a time within the maximum callback time period determined by the above steps to be the most likely time that the callback will be successful 2209.

In some embodiments, a machine learning algorithm may be trained to calculate probabilities of successful callbacks by using caller/callback training data similar to the various data types listed above. After training, actual caller data for each call or caller may be processed through the trained machine learning algorithm to calculate probabilities of successful callbacks allowing for selection of those deemed most likely to result in a successful callback.

In some embodiments, an exemplary function for an optimal callback time made by the pacing algorithm may be a function such: f(n)=|(n*C)| where n is a base value for callback time, determined by the implementation, and C may be a number which is comprised of different rates and values obtained from agent stations and client data obtained from the cloud-based system, which is also dependent on the implementation. As an example, if customer hit rate (likelihood of an answer to a callback) has a weighted value of 0.2, number of agents available has a weighted value of 0.6 and the number of failed attempts as a weighted value of 0.3—an exemplary calculation of f(n) may be as follows: |(100*[0.2(0.5)−0.6(50)+0.4(2)])| where 100 corresponds to a base time value for callbacks and the value of C is dependent on the various weighted factors and corresponding amounts. With such a function, the increase in agents available would reduce the increased time between each callback, whereas the increase in failed attempts will add time to the time between callbacks. Although this function can provide a means for increasing/decreasing the callback time based on weighted values it is not the only function which may do so; the function used for calculating the callback time is determined by the implementation of the algorithm.

According to an aspect, the calculation used for determining a callback time may increase/decrease as the pacing algorithm obtains updated information. As an example, if the number of available agents increases between the callback attempts it is possible that the duration between callbacks will be reduced. According to another aspect of this exemplary function, the implementing programmer may wish to have maximum values associated with each relevant value in the calculation. As an example, the number of available agents may no longer decrease the time between callbacks once it reaches a certain value (such as 100) in order to potentially maintain a certain minimum time for callbacks.

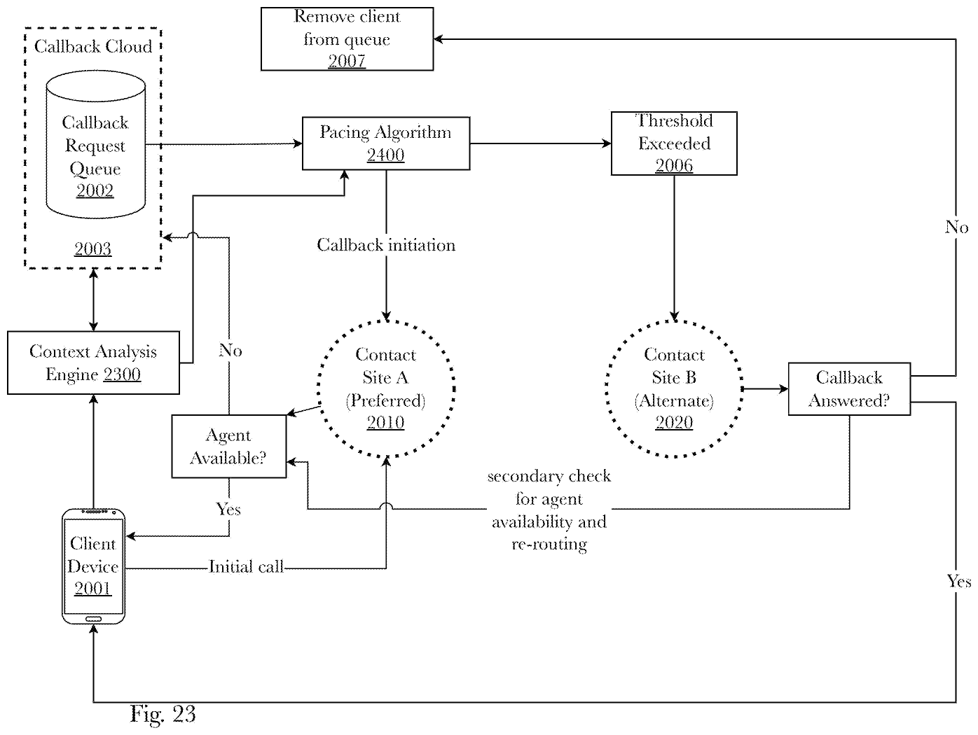

FIG. 23 is a block diagram illustrating an exemplary architecture of a system for callback management with alternate site routing and context-aware callback pacing.

A caller attempts an initial communication request to a company via a client device 2001, which is routed to a preferred contact site 2010. The communication may be made using a VOIP (Voice over Internet Protocol) connection, TDM (Time Division multiplexing) or any other form of communication of which may not be limited to exclusively voice (such as SMS, text chat, video conferencing, etc.). In cases where the caller has previously interacted with a particular agent at the preferred contact site 2010, that agent's availability may be checked first, and the caller may be preferentially connected with that agent before the call is otherwise routed. If the particular agent is not available, the call may be routed to another agent. If no agents are available, the caller is asked whether he or she would like to be called back. If the caller agrees to a callback, the call is routed to a callback queue 2002 which may be a cloud-based system 2003. In some cases, the caller may be requested to indicate a preferred callback time. In some cases, the caller's history of communications may be stored in a database associated with the callback queue 2002, and may include information such as the caller's initial call times, attempted callback times, and the percentage of callbacks that were answered by the caller at the attempted callback times.

The caller's location in the callback queue 2002 is dynamically adjusted by a pacing algorithm 2400, which assigns a location in the queue according to the likelihood of success of a callback as determined by several factors, a non-limiting list of which includes the caller's preferred times for callbacks, the caller's history of communications, a preferred agent's availability, the availability of other agents, context information obtained or derived from client device 2001 and/or some other computing device of a customer, and external events which may affect callback success (e.g., holidays, sporting events, extreme weather, etc.). Prior to initiation of a callback according to the caller's location in the queue as determined by the pacing algorithm, agent availability may be checked including the availability of a preferred agent. The pacing algorithm may retrieve information pertaining to the customer or agent (or both) for determining an optimal time of attempting the callback fulfillment attempt. For example, a non-limiting list of information about callers that may be stored and retrieved includes the caller's phone number, preferred times for callbacks, historical times of callbacks to the caller, historical percentages of answers by the caller at certain times, statistical data about individuals and groups similar to the caller, caller device information (e.g., application data, location data, contact list data), etc. In some embodiments, the pacing algorithm may also be used at the alternate contact site 2020 to determine callback times.

Each time a callback attempt is made, a callback counter may be updated. After a threshold number of unsuccessful callbacks is made 2006, the call may be routed to an alternate contact site 2020 in order to offload some of the call and/or callback volume from the preferred contact site 2010, thus leaving the preferred contact site 2010 with more resources to handle callbacks that are more likely to be successful. Information used to determine the threshold 2006 may include but is not limited to: the number of agents available at the site, the type of communication being used, the number of clients currently in the callback request queue, and the volume of callbacks at the alternate contact site 2020. In some embodiments, the threshold may also be used at the alternate contact site 2020 to determine when to route the call for handling at additional alternate contact sites (now shown), which may in some embodiments be considered lower-tier contact sites, such that a hierarchy of alternate contact sites is established.

At the alternate contact site 2020, callbacks may be processed in a manner similar to that of the preferred contact site 2010, including use of a callback queue 2002, a pacing algorithm 2400, and in some embodiments a threshold 2006 for callback failures which causes the callback handling to be routed to additional alternate sites (not shown). In this embodiment, in order to attempt to maintain consistency of communications between the caller and a preferred agent, a secondary check for that particular agent's availability may be made immediately prior to making each callback attempt. At the alternate contact site 2020, a determination may be made to remove the caller from the queue 2007 after a pre-determined number of failed callback attempts, which pre-determined number may be the same as the threshold 2006 of failed callback attempts for the alternate contact site 2020.

In some embodiments, the pacing algorithm can be extended to incorporate user intent and other contextual information associated with a user. According to the embodiment, a context analysis engine 2300 is present and configured to analyze client device 2001 data, customer interaction data in order to produce context data that can be processed by pacing algorithm 2400 as an input to determine timings and location assignment in the queue 2002. By integrating user intent and other contextual data, the pacing algorithm is augmented to predict not just availability, but timing desirability as well. As an example, a user is likely to be “available” for a callback late in the evening, but they might not want to talk to anybody then. Incorporating user intent and context information can allow pacing algorithm to consider when making predictions concepts such as, for example, when will this user likely want a callback about a given issue?, will there be any agents available when the user wants a callback?, and who is the best agent available at that time?

Pacing algorithm is configured to use known information about the original call (e.g., the call that led to callback being requested), the ongoing issue, and the customer profile. From this information, system and/or pacing algorithm is able to: know what the user's local time is, know what the user is calling about, and know what hours the user works or has other obligations. Knowledge of the reason why a user was calling (e.g., from an initial call or message) can be used by pacing algorithm to learn/identify certain issues that may be more or less relevant at certain times or on certain days. For example, if the caller is asking about international phone usage for an upcoming trip, then the system and/or pacing algorithm knows there is a deadline bounding the timing of the callback.

In some embodiments, a user (client) can provide secure access to on-device information from his or her personal computing device 2001 (e.g., smart phone, tablet, PDA, smart wearable, desktop, laptop, etc.). For instance, a user can grant permission for the system to access a calendar application operating on their computing device. By accessing the calendar application, the system is able to obtain a plurality of user information which can be used to provide context to pacing algorithm for making context-aware predictions. For example, pacing algorithm can predict timing around known events and the user schedule. The pacing algorithm goes beyond just “do not call when something is scheduled”, but enhances predictions based on what is scheduled. For example, if the user has a medical appointment scheduled, then pacing algorithm may know to probably block out that whole day from being considered for timing of a callback. As another example, if a user has a social event scheduled, then pacing algorithm can learn to apply fuzzy boundaries wherein additional time is blocked out before and after the scheduled social event, such as to account for travel time to and from the social event, or to account for the social event extending beyond the scheduled time. Alternatively, for example, if a work event is scheduled, then the system and/or pacing algorithm can learn that these events are more likely to have clean boundaries whereby a callback occurring near the scheduled work event is fine.

A user can also provide access to the contacts list on their phone in order to provide additional context information. If the system is aware of the other people the user knows, the system can determine social details that might reveal additional context. For example, if a user has “Pastor” in their contacts, then pacing algorithm can know not to schedule callbacks on Sunday mornings. Additionally, contact list information can be compared with calendar data to determine further context information.

A user can provide access to their device location data. Device location data may be leveraged by system and/or pacing algorithm 2400 to provide further context information. For example, location data can be compared against contact list information to determine when a user might be off-schedule, which indicates that a callback should not occur at this time. System and/or pacing algorithm 2400 can use device information to form behavior patterns for a user. For example, the learned or derived behavior patterns can be used by pacing algorithm to identify when the user is usually home, when they are at work, regular events the user might not bother putting on the calendar like a routine lunch with a friend or family member.

User device information can be obtained and processed by context analysis engine 2300 to produce context content data which can be used as an input into pacing algorithm 2400. Context analysis engine 2300 may include at least one environment analyzer, at least one sentiment analyzer, and at least one intent analyzer. Context analysis engine 2300 may determine, generate, or derive contextual content or attributes associated with a call, data message, session, and user device information. Contextual content may include, but are not limited to, attributes derived from a call, data message, or device information, such as end user sentiment, emotions, source data, subject matter or topic area, intended destination data, end user content, end user identification data, intent, a relationship to a second data message/call/session, or suggested contact center agent computing device to receive the data message, among other info. Environmental context data may include (for example, and not limited to) recorded information about when a callback requester or callback recipient may be suspected to be driving or commuting from work, for example, and may be parsed from online profiles or online textual data, using an environment analyzer.

Present in this embodiment of context analysis engine 2300 is a sentiment analyzer, which determines or derives sentiment contextual content which may indicate attributes such as end user sentiment or emotions. For example, a customer and contact center agent are having a text chat communication and the cloud callback platform 2003 sends a text data message scheduling a callback at 3:15 in the afternoon, but that callback time does not work for the customer so they reply with an thumbs down emoji. The sentiment analyzer may determine the thumbs down emoji indicates a negative sentiment and the cloud callback platform 2003 can reschedule the callback and send another text data message with the updated callback time. Also present in this embodiment is an intent analyzer, which analyzes spoken words or typed messages from a user that initiated the callback request, to determine or derive their intent for a callback or the intent of a data message. Intent contextual content may include intended destination data, subject matter or topic area of the callback request or data message. For example, their intent may be to have an hour-long meeting, which may factor into the decision by the cloud callback platform 2003 to place a call shortly before one or both users may be required to start commuting to or from their workplace. Context analysis engine 2300 or its analyzers may utilize any combination of text analytics, speech-to-text transcription, audio analysis, facial recognition, expression analysis, posture analysis, or other analysis techniques, and the particular technique or combination of techniques may vary according to such factors as the device type or interaction type (for example, speech-to-text may be used for a voice-only call, while face/expression/posture analysis may be appropriate for a video call), or according to preconfigured settings (that may be global, enterprise-specific, user-specific, device-specific, or any other defined scope).

Context analysis engine 2300 may parse or evaluate a data message (including any metadata such as a location, keyword, topic, or phone number) or call logs to identify at least one attribute of the data message (e.g., subject matter of the data message, or an identifier of the end user or of the customer computing device). For example, data messages may include source and destination addresses, formatted such as @thomas for social networks or +15085551212 for mobile telecom networks, along with the payload of the message, such as “I have a problem with my bill”, and various meta-data about the message such as the time of creation, a unique identifier for the message, or a Boolean flag indicating whether or not the data message has been delivered before. Based on these attributes, the context analysis engine 2300 may identify attributes of the data messages, and can generate corresponding contextual content, such as a sentiment analysis or determination for the data message. The handle identifier “@Thomas” and the destination identifier ‘@Cable Co” are examples and the attributes of the data messages. The attributes of the data message may include other identifiers, such as subject matter terms, a phone number of the customer computing device, a device identifier of the customer computing device, destination phone numbers or other identifiers of the entity that is associated with the data message (e.g., that the end user is trying to reach).

The cloud callback platform 2003 may generate, (e.g., identify, or obtain) contextual content of or corresponding to the session or a data message or from device information. For example, the context analysis engine 2300 may parse or analyze a replicated data message or the original data message (or attributes/attributes thereof) to identify contextual content. The contextual content may indicate a sentiment or other attribute of the end user at the consumer endpoint that originated the data message, or may indicate a topic or category of content of the data message, for example. The context analysis engine 2300 may link the contextual content with the data message (or replicated data message) and can provide the contextual content to the profile manager 150 for storage and subsequent retrieval.

According to the embodiment, the pacing algorithm 2400 can be further extended to incorporate “patience weighting” to various algorithm inputs to account for user intent, context, and sentiment when predicting timing of callbacks. The weighted values are then used to predict availability times. As a simple example Weights may be based on anticipated customer sentiment at a given time such as, for example, too soon and the customer may have to wait for an available agent which can exasperate the customer, too late and the customer may lose interest or try to call again, inconvenient, etc. Access to a user's calendar is useful for applying sentiment based weighting as it provides clear blocks of time where a user is likely to be amenable to receive a call. For example, a user may be more open to receiving a callback during an afternoon where their schedule is clear than during a morning where they only have thirty minutes between client meetings to engage in a callback. As another example, a user may have an important presentation scheduled and may be more likely to want a callback after the presentation when their mind is clear, than before the meeting where they may be preparing for the presentation. User sentiment is important to consider and beneficial because the attitude and disposition of the callback recipient can directly influence call outcomes and treatment of contact center agents.

According to various embodiments, the extended pacing algorithm 2400 may be trained and configured to use an aggregate score for likelihood-to-answer and sentiment-when-answered instead of just predicting a “greatest likelihood of answering”. By aggregating both a likelihood-to-answer and sentiment-when-answering, the pacing algorithm is able to make predictions wherein the customer is likely to answer, and likely to be in a good mood to continue discussing the issue. User sentiment can be weighted and used to help predict timing and call outcomes. In an example, a user speaking with a contact center agent is angry about her service and a callback is scheduled. The irritated customer may be likely to answer a callback just to vent her frustrations. In situations like these, where the user sentiment is determined to be poor, the pacing algorithm can take this into account and give the customer a “cooldown period” according to the nature of the call. During this cooldown period the customer sentiment can improve or abate such that when the callback occurs after the cooldown period, the call outcome is more beneficial to the customer and to the contact center agent. As another example, a customer may be eager to address the issue, but unable to answer due to a meeting or other scheduled event. Aggregating user intent, context, sentiment, and availability information and applying patience weighting improves pacing algorithm predictions by providing more data points to inform predictions and by accounting for the user temperament which can directly affect call outcomes.

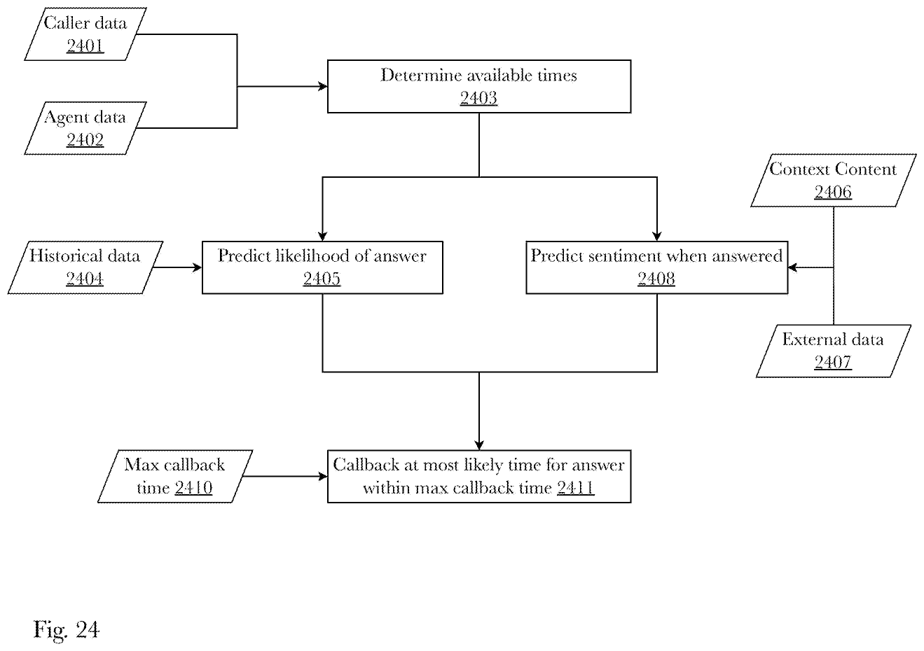

FIG. 24 is an exemplary method diagram illustrating a context-aware pacing algorithm for callback site optimization with callback time optimization and preferred agent availability re-routing. As a first step caller data 2401 and agent data 2402 are used to determine callback times at which both the caller and agent are available 2403. The agent data will generally be known according to the agent's work schedule, but may also include times of the day that are particularly busy or free for the agent or other such detailed information. The caller data may include indications of availability by the caller (such as in response to queries about convenient callback times) and/or stored histories of communications with the caller (such as previous times at which callbacks to the caller have been successful). At a second step, a likelihood of an answer by the caller at certain times may be predicted 2205 based on historical information about the caller 2204 (such as a history of previous callback times, a likelihood of the caller answering at certain times, etc.).

At a third step, an estimated user sentiment when answered may be predicted the predicted 2408 based on external data 2407 (such as holidays, sporting events, extreme weather, etc.) and context content 2406. Context content 2406 may be obtained from context analysis engine 2300 and can include environmental context data, user intent context data, and user sentiment context data each of which may be computed, measured, calculated, learned, and/or derived from user device information such as application (App) data from software applications operating on the user's computing device (e.g., email app, social media app, etc.), location data, contact list data, call log data, and/or the like. For example, on holidays, people will be both more likely to be available and answer a call, whereas during periods of extreme weather, people may be available, but less likely to answer a call. If information is known about the caller (e.g., that he or she is a fan of a particular sports team), that information may be used to adjust the likelihood that the caller will answer a callback (e.g., if that particular sports team is playing a game at the projected callback time). Each of the external data, environment context data, intent context data, and sentiment context data may be assigned a weight based on various factors. In some implementations the assigned weights may be based on the amount and richness of context data. For example, if in a customer's initial call he explicitly stated that he wanted to upgrade services and he wanted to take care of it that day, then the customer's intent (upgrade service) and sentiment (urgent) can be easily determined by context analysis engine 2300. The context content derived from this customer's initial call would be considered rich because it was explicitly stated by the customer. In this example, the weights assigned to the intent and sentiment data points may be given a larger value (e.g., thereby increasing their influence on the predicted outcome) based on the richness of the these data points. In other implementations, pacing algorithm 2400 can learn the optimal weights to assign to various external and context content data points via iterative machine learning algorithmic training and testing. For each determined available time as determined at step 2403 a likelihood of answering is predicted at step 2405, and a predicted sentiment when answered at each available time is predicted at step 2408. It should be appreciated that steps 2405 and 2408 can be performed simultaneously in parallel as illustrated, or those two steps may be performed not in parallel and in any order without limiting the scope or functionality of the system and/or pacing algorithm. The predicted likelihood of answer and the predicted sentiment when answered may be aggregated together to determine a timing for a callback and a subsequent placement in a callback request queue 2002.

Finally, callbacks after a certain number of hours or days are likely to be perceived as non-responsive, so a maximum callback time period can be established 2410, and a callback may be scheduled for a time within the maximum callback time period determined by the above steps to be the most likely time that the callback will be successful 2411.

In some embodiments, a machine learning algorithm may be trained to calculate probabilities of successful callbacks by using caller/callback training data similar to the various data types listed above. In some implementations, context content training and test data may be sourced from surveys or questionnaires filled out by customers, wherein the surveys and/or questionnaires ask for user intent or sentiment before, during, and/or after a call, callback, or interaction with a contact center. This information may be linked with other customer call information such as a scheduled callback time, a call outcome, and historical user information to form a dataset where user context data can be correlated with callback data (e.g., when/if a customer answered at a specified time and the outcome associated with a callback) in order to train pacing algorithm to learn complex and/or hidden relationships between various types of context content and its effect on the likelihood a callback is answered by a customer. After training, actual context data and caller data for each call or caller may be processed through the trained machine learning algorithm to calculate probabilities of successful callbacks allowing for selection of those deemed most likely to result in a successful callback.

In some embodiments, an exemplary function for an optimal callback time made by the pacing algorithm may be a function such: f(n)=|(n*C)+(m*S)| where n is a base value for callback time, determined by the implementation, C may be a number which is comprised of different rates and values obtained from agent stations and client data obtained from the cloud-based system and which is also dependent on the implementation, where m is a base value for user sentiment, and S may be a number which is comprised of different rates and values associated with context content data obtained from agent stations, client data, device information, and external data, wherein m and S are also dependent on the implementation. As an example, if customer hit rate (likelihood of an answer to a callback) has a weighted value of 0.2, number of agents available has a weighted value of 0.6 and the number of failed attempts as a weighted value of 0.3—an exemplary calculation of f(n) may be as follows: |(100*[0.2(0.5)−0.6(50)+0.4(2)]| where 100 corresponds to a base time value for callbacks and the value of C is dependent on the various weighted factors and corresponding amounts. Continuing the previous example, if environmental context has a weighted value of 0.1, sentiment context has a weighted value of 0.7, and intent context has a weighted value of 0.8—an exemplary calculation of f(n) may be as follows |(100*[0.2(0.5)−0.6(50)+0.4(2)])+(50*[0.1(environment)+0.7(sentiment)+0.8(intent)]| where 50 corresponds to a base sentiment value and the value of S is dependent on various weighted factors and corresponding amounts. In this way, pacing algorithm accounts not only on a predicted likelihood of answer but also for a user's predicted sentiment when answering the call. With such a function, the increase in agents available would reduce the increased time between each callback, whereas the increase in failed attempts will add time to the time between callbacks. Although this function can provide a means for increasing/decreasing the callback time based on weighted values it is not the only function which may do so; the function used for calculating the callback time is determined by the implementation of the algorithm.

According to an aspect, the calculation used for determining a callback time may increase/decrease as the pacing algorithm obtains updated information. As an example, if the number of available agents increases between the callback attempts it is possible that the duration between callbacks will be reduced. According to another aspect of this exemplary function, the implementing programmer may wish to have maximum values associated with each relevant value in the calculation. As an example, the number of available agents may no longer decrease the time between callbacks once it reaches a certain value (such as 100) in order to potentially maintain a certain minimum time for callbacks. As another example, the sentiment value m can be set at whatever baseline value (such as 50) an enterprise of contact center feels is the minimum sentiment value which can lead to a positive and worthwhile call outcome for the contact center and for the customer.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (“ASIC”), or on a network interface card.

Software/hardware hybrid implementations of at least some of the aspects disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific aspects, at least some of the features or functionalities of the various aspects disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof In at least some aspects, at least some of the features or functionalities of the various aspects disclosed herein may be implemented in one or more virtualized computing environments (e.g., network computing clouds, virtual machines hosted on one or more physical computing machines, or other appropriate virtual environments).

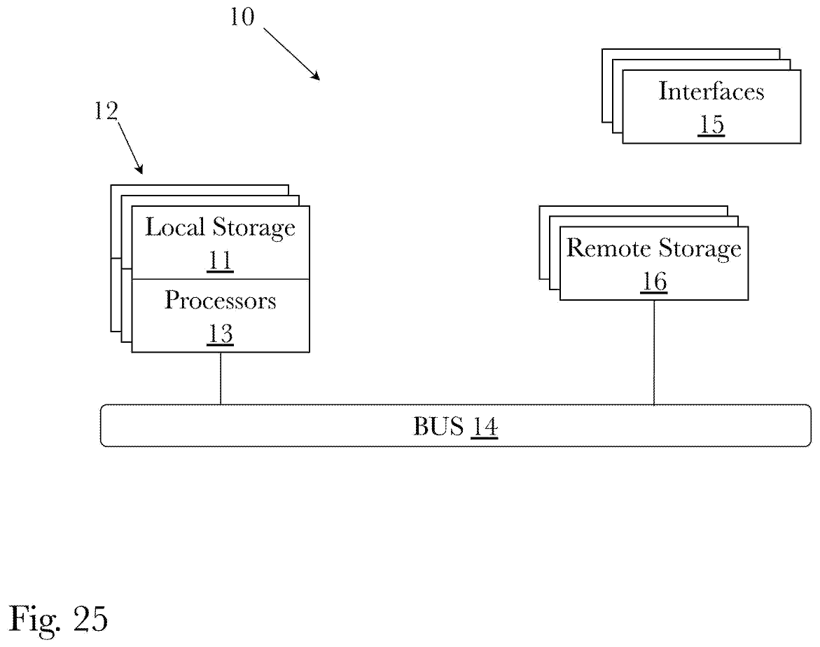

Referring now to FIG. 25, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 10 includes one or more central processing units (CPU) 12, one or more interfaces 15, and one or more buses 14 (such as a peripheral component interconnect (PCI) bus). When acting under the control of appropriate software or firmware, CPU 12 may be responsible for implementing specific functions associated with the functions of a specifically configured computing device or machine. For example, in at least one embodiment, a computing device 10 may be configured or designed to function as a server system utilizing CPU 12, local memory 11 and/or remote memory 16, and interface(s) 15. In at least one embodiment, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a specific embodiment, a local memory 11 (such as non-volatile random access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 25 illustrates one specific architecture for a computing device 10 for implementing one or more of the inventions described herein, it is by no means the only device architecture on which at least a portion of the features and techniques described herein may be implemented. For example, architectures having one or any number of processors 13 may be used, and such processors 13 may be present in a single device or distributed among any number of devices. In one embodiment, a single processor 13 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine- readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

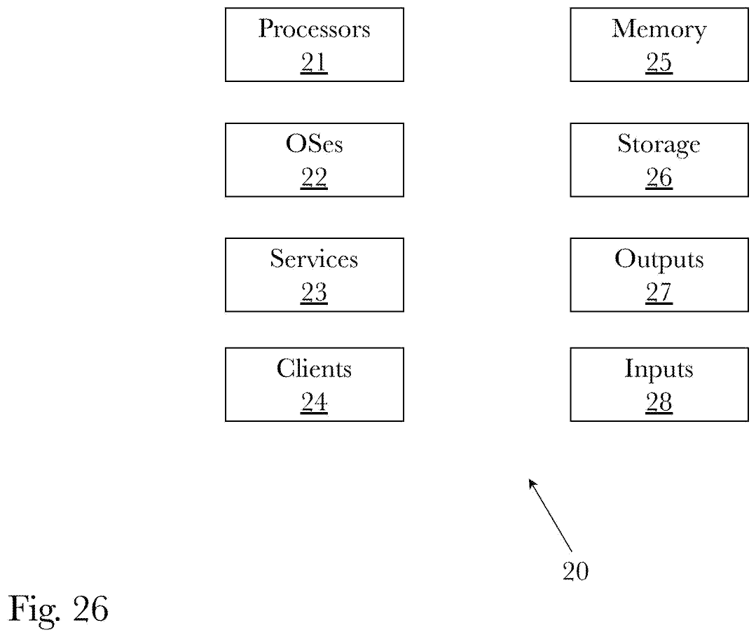

In some embodiments, systems according to the present invention may be implemented on a standalone computing system. Referring now to FIG. 26, there is shown a block diagram depicting a typical exemplary architecture of one or more embodiments or components thereof on a standalone computing system. Computing device 20 includes processors 21 that may run software that carry out one or more functions or applications of embodiments of the invention, such as for example a client application 24. Processors 21 may carry out computing instructions under control of an operating system 22 such as, for example, a version of MICROSOFT WINDOWS™ operating system, APPLE OSX™ or iOS™ operating systems, some variety of the Linux operating system, ANDROID™ operating system, or the like. In many cases, one or more shared services 23 may be operable in system 20, and may be useful for providing common services to client applications 24. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 25). Examples of storage devices 26 include flash memory, magnetic hard drive, CD-ROM, and/or the like.

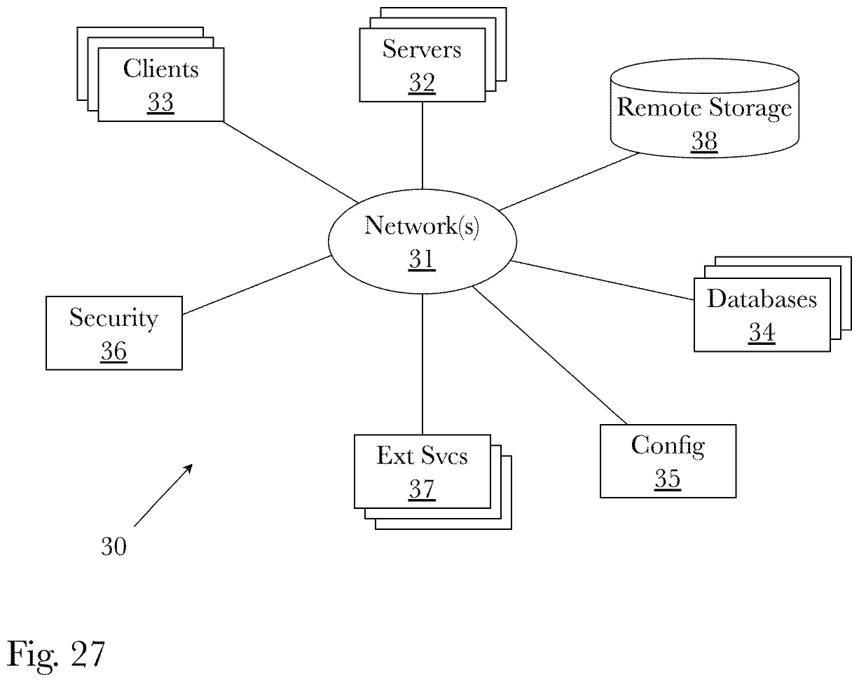

In some embodiments, systems of the present invention may be implemented on a distributed computing network, such as one having any number of clients and/or servers. Referring now to FIG. 27, there is shown a block diagram depicting an exemplary architecture 30 for implementing at least a portion of a system according to an embodiment of the invention on a distributed computing network. According to the embodiment, any number of clients 33 may be provided. Each client 33 may run software for implementing client-side portions of the present invention; clients may comprise a system 20 such as that illustrated in FIG. 26. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the invention does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in an embodiment where client applications 24 are implemented on a smartphone or other electronic device, client applications 24 may obtain information stored in a server system 32 in the cloud or on an external service 37 deployed on one or more of a particular enterprise's or user's premises.

In some embodiments of the invention, clients 33 or servers 32 (or both) may make use of one or more specialized services or appliances that may be deployed locally or remotely across one or more networks 31. For example, one or more databases 34 may be used or referred to by one or more embodiments of the invention. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 36 or configuration system 35 or approach is specifically required by the description of any specific embodiment.

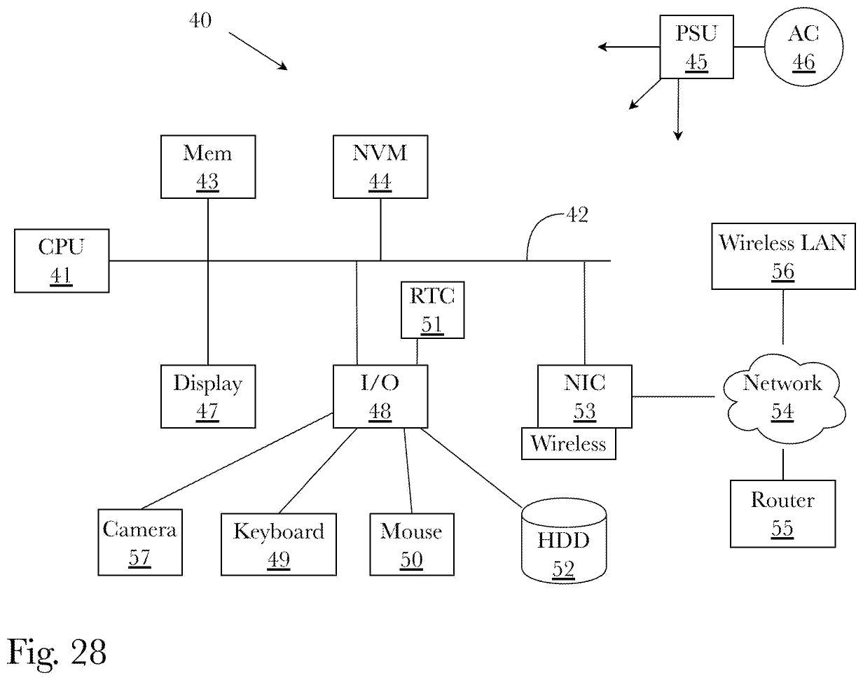

FIG. 28 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to peripherals such as a keyboard 49, pointing device 50, hard disk 52, real-time clock 51, a camera 57, and other peripheral devices. NIC 53 connects to network 54, which may be the Internet or a local network, which local network may or may not have connections to the Internet. The system may be connected to other computing devices through the network via a router 55, wireless local area network 56, or any other network connection. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

The skilled person will be aware of a range of possible modifications of the various embodiments described above. Accordingly, the present invention is defined by the claims and their equivalents.

What is claimed is:

1. A system for callback management with alternate site routing and context-aware callback pacing, comprising:
a computing device comprising a memory and a processor;
a context analysis engine comprising a first plurality of programming instructions stored in the memory and operating on the processor, wherein the first plurality of programming instructions, cause the computing device to:
receive device information, caller data, and external data;
process the device information, the caller data, and the external data to generate context content data; and
forward the context content to a pacing algorithm; and
the pacing algorithm comprising a second plurality of programming instructions stored in the memory and operating on the processor of the computing device, wherein the second plurality of programming instructions, cause the computing device to:
receive callback objects from a callback cloud service;
determine times when a caller and an agent are both likely to be available;
predict a likelihood that the caller will answer at each determined time;
predict a caller sentiment when answering at each determined time;
aggregate the predicted likelihood that the caller will answer and the predicted caller sentiment when answering to select a callback time; and
send the callback time to an on-premise callback system.

2. The system of claim 1, further comprising an on-premise callback system operating at a preferred contact site comprising a third plurality of programming instructions stored in the memory and operating on the processor of the computing device, wherein the third plurality of programming instructions, cause the computing device to:
communicate with the callback cloud service;
send data related to callback objects and agents to the callback cloud service;
receive a call to an agent from a caller;
create a callback object upon the caller's request for a callback;
receive the callback time from a pacing algorithm; and
execute a callback to the caller at the callback time.

3. The system of claim 2, further comprising the callback cloud service comprising a second computing device comprising a memory and a processor, and a fourth plurality of programming instructions stored in the memory and operating on the processor of the second computing device, which causes the second computing device to:
communicate with the on-premise callback system;
maintain relevant agent and client data from the on-premise callback system;
interface with one or more alternate sites comprising of an on-premise callback system; and
execute callback fulfillment requests.

4. The system of claim 1, wherein the pacing algorithm further:
determines a callback attempt limit;
increments a counter each time a failed callback is made to the caller; and
upon reaching callback attempt limit, routes remaining callback attempts to an alternate contact site.

5. The system of claim 4, further comprising a second on-premise callback system operating at an alternate contact site, the second on-premise callback system comprising a third computing device comprising a memory and a processor, and a fourth plurality of programming instructions stored in the memory and operating on the processor of the third computing device, which causes the third computing device to:
receive the routing from the pacing algorithm;
determine a callback time;
immediately prior to the callback time, determine whether a preferred agent at the preferred callback site is available;
if the preferred agent is available, route the callback to the preferred contact site for execution; and
if the preferred agent is not available, execute the callback to the caller from the alternate contact site.

6. The system of claim 1, wherein the device information comprises application data, device location data, contact list data, and schedule data.

7. The system of claim 1, wherein the context content data comprises environmental context data, intent context data, and sentiment context data.

8. The system of claim 1, wherein the context content data is assigned weighted values.

9. The system of claim 8, wherein the assigned weighted values are based on the richness of the context content data.

10. The system of claim 8, wherein the assigned weights values are learned and assigned by the pacing algorithm.

11. A method for callback management with alternate site routing and context-aware callback pacing, comprising the steps of:
receiving device information, caller data, and external data;
processing the device information, the caller data, and the external data to generate context content data;
forwarding the context content to a pacing algorithm;
receiving callback objects from a callback cloud service;
determining times when a caller and an agent are both likely to be available;
predicting a likelihood that the caller will answer at each determined time;
predicting a caller sentiment when answering at each determined time;
aggregating the predicted likelihood that the caller will answer and the predicted caller sentiment when answering to select a callback time; and
sending the callback time to an on-premise callback system.

12. The method of claim 11, further comprising the steps of:
communicating with the callback cloud service;
sending data related to callback objects and agents to the callback cloud service;
receiving a call to an agent from a caller;
creating a callback object upon the caller's request for a callback;
receiving the callback time from a pacing algorithm; and
executing a callback to the caller at the callback time.

13. The method of claim 12, further comprising the steps of:
communicating with the on-premise callback system;
maintaining relevant agent and client data from the on-premise callback system;
interfacing with one or more alternate sites comprising of an on-premise callback system; and
executing callback fulfillment requests.

14. The method of claim 11, further comprising the steps of:
determining a callback attempt limit using the pacing algorithm;
incrementing a counter each time a failed callback is made to the caller using the pacing algorithm; and
upon reaching callback attempt limit, routing remaining callback attempts to an alternate contact site using the pacing algorithm.

15. The method of claim 14, further comprising the steps of using a second on-premise callback system operating on a third computing device at the alternate contact site to:
receive the routing from the pacing algorithm;
determine a callback time;
immediately prior to the callback time, determine whether a preferred agent at the preferred callback site is available;
if the preferred agent is available, route the callback to the preferred contact site for execution; and
if the preferred agent is not available, execute the callback to the caller from the alternate contact site.

16. The method of claim 11, wherein the device information comprises application data, device location data, contact list data, and schedule data.

17. The method of claim 11, wherein the context content data comprises environmental context data, intent context data, and sentiment context data.

18. The method of claim 11, wherein the context content data is assigned weighted values.

19. The method of claim 18, wherein the assigned weighted values are based on the richness of the context content data.

20. The method of claim 18, wherein the assigned weights values are learned and assigned by the pacing algorithm.
